(19) United States
(12) Patent Application Publication
(10) Pub. No.: US 2014/0229407 A1
(43) Pub. Date: Aug. 14, 2014

(54) DISTRIBUTING RELEVANT INFORMATION TO USERS OF AN ENTERPRISE NETWORK

(71) Applicant: salesforce.com, inc., San Francisco, CA (US)

(72) Inventor: Scott Douglas White, Seattle, WA (US)

(73) Assignee: salesforce.com, inc., San Francisco, CA (US)

(21) Appl. No.: 14/180,222

(22) Filed: Feb. 13, 2014

Related U.S. Application Data
(60) Provisional application No. 61/764,703, filed on Feb. 14, 2013.

(51) Int. Cl. G06N 99/00

(52) U.S. Cl. CPC G06N 99/005
USPC 706/12; 706/46

(57) ABSTRACT

Various implementations are directed to systems, apparatus, computer-implemented methods and storage media for identifying a target set of users of an enterprise network to which to distribute a communication of enterprise-related information. For example, when a communication system receives a request to distribute a communication, the communication system analyzes the communication to identify a set of enterprise users that are predicted to find the information in the communication relevant, and especially, relevant from the enterprise's perspective. For example, the communication system can include a machine learning system that can construct, update and maintain a machine learning model of induction. In some implementations, the machine learning system trains the machine learning model by identifying contextual features of previously distributed communications, user traits of recipients of the previously distributed communications, and actions or inactions that indicate whether the recipients found the information in the communications relevant.

### PRIORITY DATA

This patent document claims priority to co-pending and commonly assigned U.S. Provisional Patent Application No. 61/764,703, titled “Targeting Information in Enterprise Social Networks”, by White, filed on Feb. 14, 2013 (Attorney Docket No. 1027PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This patent document relates generally to distributing relevant information to users of an enterprise network and, more specifically, to learning from past distributions of enterprise-related information to identify users to whom to target future communications of relevant enterprise-related information.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

Database resources can be provided in a cloud computing context. However, using conventional database management techniques, it is difficult to know about the activity of other users of a database system in the cloud or other network. For example, the actions of a particular user, such as a salesperson, on a database resource may be important to the user's boss. The user can create a report about what the user has done and send it to the boss, but such reports may be inefficient, not timely, and incomplete. Also, it may be difficult to identify other users who might benefit from the information in the report.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows a flowchart of an example method for tracking updates to a record stored in a database system according to some implementations.

FIG. 4 shows a flowchart of an example method for tracking actions of a user of a database system according to some implementations.

FIG. 5 shows an example of a group feed on a group page according to some implementations.

FIG. 6 shows an example of a record feed including a feed tracked update, a post, and comments according to some implementations.

FIG. 7 shows a flowchart of an example computer-implemented method for constructing a machine learning model that can be used to identify a target set of relevant enterprise users to which to send or display a communication according to some implementations.

FIG. 8A shows a representation of a three-dimensional machine learning model.

FIG. 8B shows a decision boundary in the machine learning model of FIG. 8A.

FIG. 9 shows a flowchart of an example computer-implemented method for updating a machine learning model that can be used to identify a target set of relevant enterprise users to which to send or display a communication according to some implementations.

FIG. 10 shows a flowchart of an example computer-implemented method for using a machine learning model to identify a target set of relevant enterprise users to which to send or display a communication according to some implementations.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, such that the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A or B” is intended to include the possibilities of “A,” “B,” and “A and B.”

Various implementations described and referenced herein are directed to systems, apparatus, computer-implemented methods, and computer-readable storage media for identifying a target set of relevant users of an enterprise network to which to send or display a communication of enterprise-related information. For example, when a communication system of an enterprise, such as a business corporation, partnership or organization (also referred to herein collectively as an “enterprise”), receives a request to distribute a communication or otherwise determines that a communication should be distributed, the communication system can analyze the communication to identify a group of employees or members of the enterprise (also referred to herein collectively as “enterprise users”) that are predicted to find the information in the communication relevant, and especially, relevant from the enterprise's perspective. For example, the communication system can include a machine learning system that can construct, update and maintain a statistical model of induction (also referred to herein simply as a “machine learning model”). The machine learning model can be constructed or updated (“trained”) on previously distributed communications to these or other employees or members in an enterprise network. For example, the machine learning system can train the machine learning model by identifying contextual features of previously distributed communications, user traits of recipients of the previously distributed communications, and actions or inactions that indicate whether the recipients found the information in the communications relevant. In this way, when a future communication is to be distributed in the enterprise network, the communication system can identify one or more contextual features of the communication and, in conjunction with the machine learning model, identify those enterprise users that would likely find the information in the communication relevant based on their respective user traits. In various implementations, the communication can be distributed to each targeted enterprise user as an email, or displayed to each targeted enterprise user as a feed item, among other suitable forms of distribution.

For didactic purposes, consider an example in which the organization Acme Corp. is a global software company based in San Francisco, Calif. with 10,000 employees and over 500 teams. Suppose that, of the 10,000 employees, 3000 have laptops and 1000 of them live in New York City. The organization has learned that there has been a recent increase in laptop thefts at the New York City office. The organization's security team would like to make certain that those employees who own laptops in New York City have cable locks for their laptops to lock up their laptops when they leave their desks. The security team sends an announcement (for example, an email or a feed item) to a “Laptop” group, which includes 150 “subscribers” or members. In this case, only the people who subscribe to or are already members of the Laptop group receive the announcement and, as can be typical in enterprise networks, most of them do not bother to forward the announcement to or otherwise inform their peers who also have laptops.

Suppose also that recipients of the announcement have some means to which to indicate the relevance of the announcement. For example, consider that the announcement may be presented with a feedback mechanism that enables the recipients to mark the announcement as “helpful” or “unhelpful.” In such a use scenario, a machine learning system can identify and record all of those recipients—for example say 50 people—who marked the announcement as helpful or relevant. Suppose also that the machine learning system also identifies and records all of those recipients—for example say 30 people—who marked the announcement as unhelpful or irrelevant. However, given such as small data sample, especially when compared with the total number of enterprise users that may be in the organization, it can be useful to collect more negative examples (that is, cases in which recipients found a communication unhelpful or irrelevant) to avoid drawing overgeneralized conclusions from the data set. For example, the security team can then distribute the announcement to a “General Announcements” group that includes a much greater number of subscribers or members. Assume now that the machine learning system determines and records that only 10 recipients in the General Announcements group indicate the announcement is helpful while 40 recipients indicate it is not helpful.

The machine learning system can now construct or update a machine learning model that includes 60 positive instances (cases in which the recipient indicated the announcement was helpful) and 40 negative instances (cases in which the recipient indicated the announcement was not helpful). For at least those recipients from which an indication of helpfulness or relevance (whether positive or negative) was identified or determined, various user traits of those recipients are tracked and recorded. For example, such user traits can include gender, age, location, occupational role, and salary, among others as described further below. The machine learning system trains the machine learning model on this data and subsequently determines decision boundaries or predicted relevancy values.

As an example of a decision boundary characterized as a rule, the machine learning system can determine that people with the occupational role of “Software Developer” or “Sales Professional,” whose location is in “New York City,” and whose salary is greater than $50,000 should be targeted with the same or similar security announcements in the future. That is, the machine learning system can learn that this subset of people would likely find the announcement relevant because it turns out that, for example, 85% of software developers and salespeople working in New York City and earning more than $50,000 have a laptop. And, for example, it may be determined that only 20% of all of the people who own laptops and work in New York City do not meet this criteria. As such, the machine learning system, by training on actual data, is able to precisely target, to a much better degree than could be done by the security team, exactly which people working in the New York City office use laptops and notify such relevant enterprise users while not inundating other enterprise users with unhelpful or irrelevant announcements.

Conventional distribution models for communicating information to users of computing systems and networks include two general categories. The first is a “pull” model. In a conventional example of a pull model, an enterprise user can request to receive communications over a data network that include information from or about certain other enterprise users, groups, database records or other data objects. The second distribution model is a “push” model. In a conventional example of a push model, an enterprise or the enterprise's agents may target particular groups of enterprise users to receive communications based on one or more of a hierarchical role model (for example, all employees, all employees of a particular division, or all employees of a particular department or group), an assignment of ownership or responsibility (such as of a record, document, task, project or opportunity), or a level of importance.

An increasing challenge as the use of electronic communication becomes more widespread and frequent, especially for enterprises with numerous enterprise users, is how to efficiently distribute communications that include enterprise-related information relevant to the respective enterprise users receiving the communications, while not distributing such communications to enterprise users for which the information is not relevant. Another challenge for business enterprises or other organizations is the avoidance of duplicative communications. For example, in a conventional subscription model scenario, because a particular user may subscribe to multiple enterprise users, groups, records or other data objects (also referred to collectively herein as “information sources” or simply “sources”) designated to receive the information in a particular communication, that user may receive multiple copies of that communication. In a conventional push model scenario example, because a particular user may belong to multiple groups, departments, or divisions designated to receive the information in the communication, or because the user may work on multiple documents, tasks, projects, or opportunities for which the information in the communication pertains, that user may receive multiple copies of that communication.

It has been observed that when enterprise users receive a large number of often irrelevant communications (some of which may be duplicative communications because such employees are in or are subscribed to multiple sources) some of such enterprise users eventually (and in some cases increasingly over time) tend to, in the case of email communications for example, either manually delete such communications before reading them or set up automatic filters or rules to automatically have such communications be forwarded to or placed in a trash or spam/junk folder of their email account. However, sometimes the manually- or automatically-deleted communications are in fact relevant from the enterprise's perspective. For example, it can be desirable from an enterprise's perspective to distribute communications to a targeted set of enterprise users (also referred to herein as “relevant enterprise users”) in situations in which the distribution of the communications to such relevant enterprise users would benefit the enterprise by virtue of these relevant enterprise users having knowledge of the information contained in the communications. To reduce the likelihood that relevant communications are filtered, ignored, missed, not read or are deleted by enterprise users before reading, it is desirable to limit the number of irrelevant communications the enterprise users receive.

Similarly, in enterprise social networks, enterprise users who are inundated with a large number of, for example, irrelevant enterprise-related feed items in their respective enterprise news feeds may actually lose interest in the feeds or perhaps not see or recognize important or otherwise relevant enterprise-related information contained in a particular feed item. For example, a relevant enterprise-related feed item may be virtually “lost” or “buried” in a plethora of irrelevant feed items. Additionally, some enterprise users may block communications such as feed items generated by, or in response to activity concerning, particular sources of information such as particular enterprise users, groups, or other senders, or particular records or other data objects. In the case of a subscription model, some enterprise users may unfollow or unsubscribe to various sources of information if inundated with too many irrelevant communications from such sources. However, as with the email example above, sometimes the information is in fact relevant from the employer's or organization's perspective. And so, similarly, to reduce the likelihood that relevant communications are ignored, missed, not read or are blocked by enterprise users, or that sources of relevant information are not unfollowed or unsubscribed to, it is desirable to limit the number of irrelevant communications the enterprise users receive.

Deterministic routing algorithms have been used to facilitate the distribution of information. But deterministic routing algorithms can have severe drawbacks, especially for enterprise social network feeds. For example, if the routing of feed items is deterministic based on the respective sources of the information in the feed items, for example, based on the users, groups, records or other data objects the user subscribes to, then the onus is essentially on the enterprise user to find, identify and subscribe to all sources of potentially relevant information. However, many enterprise users often don't know, for example, which groups to subscribe to or which records to follow, or may not care—at least enough to find and identify such groups or records.

Similarly, it has been observed that many enterprise users won't actively subscribe to notifications or communications related to information that is important or otherwise relevant from the enterprise's perspective, such as those communications that would benefit the enterprise by virtue of the enterprise users knowing the information, but uninteresting from the user's perspective, such as, for example, software update notifications. Rather, or instead, enterprise users are typically more interested in information that is useful or advantageous to them from a more personal or social perspective, and so, generally subscribe only to, or mostly to, groups for which they may receive communications involving or pertaining to such information. As such, in enterprise social networks, it is suboptimal from the enterprise's perspective if the only information that is distributed to employees is information that the employees have actively subscribed to or explicitly stated they are interested in or find useful; because the likely result is that many enterprise users would miss relevant communications. Such relevant communications may include, for example, important updates or notifications, such as updates for software or updates on opportunities, or notifications concerning critical announcements, such as announcements relating to legal compliance, that may pertain to only a subset of enterprise users. However, although some enterprise users wouldn't actively subscribe to certain sources of potentially relevant information, if such enterprise users received communications of such relevant enterprise-related information, they may still find it important or otherwise relevant from the enterprise's perspective, and so, would read or otherwise pay attention to the communication as long as they weren't inundated with too many other irrelevant communications.

Similarly, if the onus is on the enterprise's management to determine which enterprise users or groups of users need to receive particular communications containing important or otherwise relevant enterprise-related information, then the management would conventionally have to identify which users need to see the information (the relevant enterprise users) while not including other users (also referred to as “irrelevant enterprise users”) that do not need to see the information because, for example, the viewing or knowing of such information by the irrelevant users would provide no benefit to the enterprise and likely no benefit to the user either. That is, as described above, if management is overly inclusive and distributes too many irrelevant communications to irrelevant enterprise users, they risk desensitizing the currently irrelevant enterprise users from future communications that such enterprise users would find relevant, and resulting in some of such desensitized enterprise users missing potentially critical or advantageous information, especially from the enterprise's perspective, in the future communications.

Another challenge for enterprises that publish news feeds to users is how to prioritize the information published in the users' respective feeds. For example, typical enterprise social network news feeds are different from typical consumer-facing social network news feeds (for example, Facebook®) in many ways, including in the way they prioritize information. In consumer-facing social networks, the focus is generally on helping the social network users find information that they are interested in and excited about. But in enterprise social network applications, as described above, it can be desirable from an enterprise's perspective to distribute communications to a targeted set of relevant enterprise users in situations in which the distribution of the communications to such enterprise users would benefit the enterprise by virtue of these enterprise users knowing the information contained in the communications. Enterprises may desire to prioritize such enterprise-serving information in certain enterprise users' respective feeds. Thus, the meaning of relevance differs significantly in the context of a consumer-facing social network as compared with an employee-facing or organization member-facing enterprise social network.

Various implementations described or referenced herein relate generally to distributing relevant information to users of an enterprise network and, more specifically, to machine-based learning from past distributions of enterprise-related information to identify users to whom to target future communications of relevant enterprise-related information. As used herein, relevant enterprise-related information refers to information that would benefit the enterprise by virtue of the recipients knowing the information. As described above, relevant enterprise-related information, although benefiting the enterprise, also generally benefits the user as well. Additionally, as used herein, an enterprise network can refer to virtually any type of enterprise electronic communication system. For example, an enterprise network can refer to an email system as well to an enterprise social network (for example, Chatter®) as described in more detail below.

Some particular implementations are directed to methods, apparatus, systems, and computer-readable storage media for identifying a target set of relevant enterprise users to which to send or display (also referred to herein collectively as “distribute”) an enterprise-related user communication. For example, in some of the implementations described herein, user communications generally can be or can include: user-submitted messages such as emails, posts, comments, indications of a user's personal preferences such as “likes” and “dislikes”, updates to a user's status, uploaded files, and hyperlinks or other references to enterprise social network data or other network data such as various documents, records or web pages accessible via an enterprise's file system or intranet or over the Internet. Some or all of such user-submitted communications can be presented as feed items in a feed or other list to a targeted user. In some implementations, user communications also can be or can include automatically-generated messages created and distributed to one or more enterprise users in response to user actions or in response to events. Such automatically-generated user communications may include, for example, information updates, software updates (for example, anti-virus software updates), alerts, and other notifications. Again, some or all of such automatically-generated communications can be presented in a feed or other list.

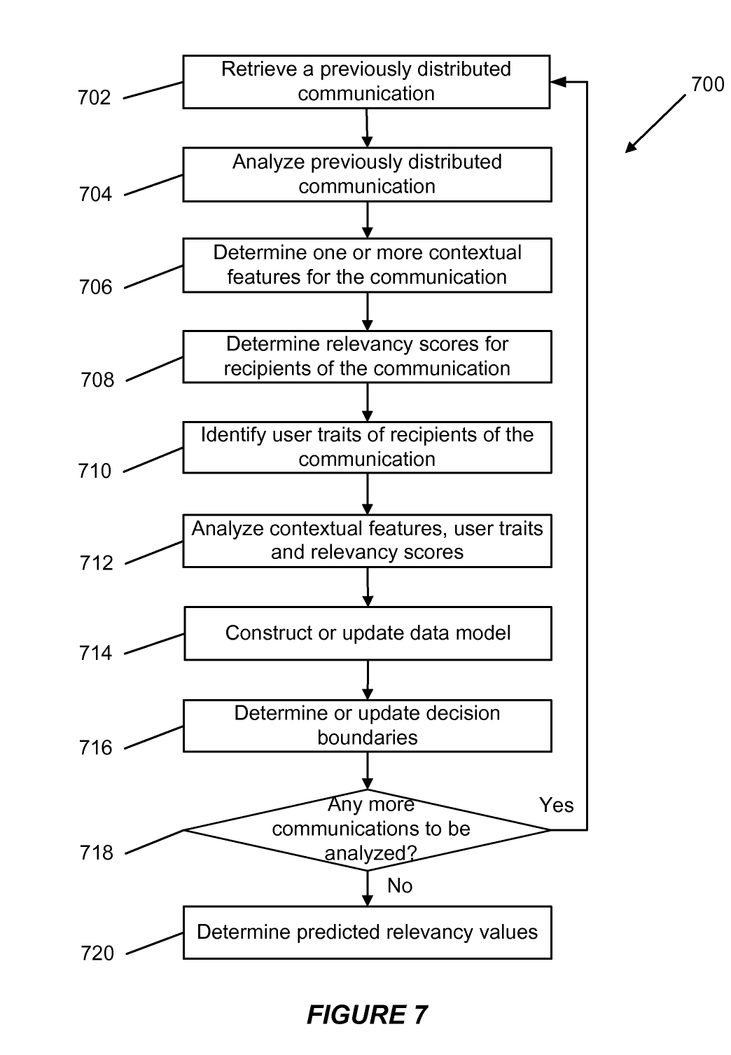

Some implementations relate to apparatus, systems, computer-implemented methods, and computer-readable storage media for constructing or updating (herein “constructing” and “updating” may be used interchangeably) a machine learning model useful for identifying the target set of relevant enterprise users. For example, the machine learning model can be used to determine one or more decision boundaries that can then be used to identify the target set of relevant enterprise users. Various implementations of the machine learning model include or make use of actual relevancy knowledge ascertained from feedback or other actions or inactions taken by various enterprise users in response to receiving previously distributed communications. For example, after a communication is sent or displayed to an enterprise user, relevancy scores for various contextual features of the communication (for example, the content, subject, purpose, objective, importance or source of the communication) can be determined for the user based on one or more respective actions or inactions taken (or not taken) by the user in response to receiving the communication. The machine learning system can update the machine learning model based on the relevancy scores, one or more user traits of the enterprise users for which the relevancy scores were determined, and the contextual features of the communication. In some particular implementations, the machine learning model can include a variety of user traits and user trait values, and for each combination of user trait values, the machine learning model can associate a respective relevancy value for a particular contextual feature based on determined relevancy scores. Some example implementations of a machine learning model, and the updating of such a machine learning model, are described in more detail below with reference to FIGS. 7-9.

Such actual relevancy knowledge based on previously distributed communications can be leveraged to predict the relevance of enterprise-related information in future communications to recipients of the previously distributed communications, as well as to enterprise users that were not recipients of the previously distributed communications. To this end, some implementations relate to apparatus, systems, computer-implemented methods, and computer-readable storage media for updating a machine learning model with predicted relevancy values (also referred to herein generally as “relevancy values”) for various user traits or combinations of user traits based on contextual features. For example, relevancy scores can be determined for recipients of a previously distributed communication and associated with one or more shared user traits of these previous recipients and associated with the contextual features of the communication. In a more specific example, relevancy scores can be associated with those shared user traits determined to have a correlation or association with the relevance of the information in the communication to these recipients. Based on such relevancy scores, various new relevancy values can be predicted, or existing relevancy values can be updated, in the machine learning model for these and other combinations of user trait values and contextual features.

The relevancy values can then be used to identify combinations of user traits associated with enterprise users to whom the information in a proposed communication is predicted or expected to be relevant. In other words, in some implementations, when a communication is to be distributed, one or more contextual features associated with the communication are identified and input into the machine learning model, which may output a set of probabilities for user traits or combinations of user traits based on the relevancy values. In some more particular implementations, the machine learning model outputs a set of probabilities for each of all or a subset of the candidate enterprise users (for example, all employees or members of the enterprise or all users of the enterprise social network) that indicate the respective likelihoods that the information in the communication to be distributed is relevant to these users. Thus, in implementations in which the machine learning model outputs probabilities associated with respective enterprise users, the machine learning model includes the identities or identifiers of the enterprise users and links between the user identifiers and their respective user trait values. In some implementations, the probabilities are compared with a threshold and those enterprise users whose probabilities are above the threshold are selected to receive the communication.

In some other implementations in which the machine learning model outputs probabilities for user trait values or combinations of user trait values, the probabilities can be compared with a threshold value and those user trait values or combinations of user trait values having probabilities above the threshold are identified. In some such implementations, these identified combinations of user traits can then be compared with the user traits of the candidate enterprise users (for example, all users of the enterprise or enterprise social network) to identify the relevant enterprise users of the larger set of candidate enterprise users.

In some implementations, the machine learning system determines decision boundaries in the machine learning model that distinguish certain users (or combinations of user trait values) having relevancy values above the threshold from users (or combinations of user trait values) having relevancy values below the threshold. In some such implementations, each decision boundary can be associated with a particular contextual feature or a particular combination of two or more contextual features.

In various implementations, the apparatus or systems described above include a machine learning system, and more particularly an active machine learning system, that constructs and updates the machine learning model based on the relevancy scores, user traits and contextual features associated with previously distributed communications and the recipients of the communications. In some other implementations, the apparatus or systems described above can utilize a third-party provider to provide the services of a machine learning system.

Additionally, at least because enterprises and enterprise social networks can be dynamic entities having changing communication needs, different employees or other enterprise users at different times, employees or other enterprise users having different positions or titles or responsibilities at different times, or enterprise users having different needs at different times, in some implementations, the machine learning model can be automatically updated. For example, the machine learning model can be automatically updated according to the changing correlation of the relevance of certain information to certain user traits to ensure that the machine learning model includes accurate relevancy values and decision boundaries for the various combinations of current user trait values associated with the current set of users belonging to the enterprise or enterprise network. In implementations using an online machine learning system, such analysis and updating as just described can be performed substantially in real time for each communication after it is distributed or, more specifically, as one or more relevancy scores are determined for the communication based on actions or inactions by recipients of the communication.

In some implementations in which an offline machine learning system is used, the machine learning system can automatically update the machine learning model when, for example, it is determined that the existing relevancy values are no longer valid or reliable. For example, based on relevancy scores indicating a lack of relevance ascertained from a number of predicted relevant enterprise users for a number of communications over a sufficient period of time, it may be determined that the relevancy values in the machine learning model need to be updated. The machine learning system can then be used to update the machine learning model until, for example, all or a subset of the communications sent since the last machine learning model update are processed. For example, the machine learning system can continue to update the machine learning model until the relevancy scores determined for the enterprise users in response to these communications are analyzed and used in updating the machine learning model. In some other implementations, the machine learning system can be used to update the machine learning model until a desired level of confidence in the relevancy values, or in the machine learning model overall, is achieved.

In some implementations, the users described herein are users (or “members”) of an interactive online enterprise “social” network, also referred to herein as an enterprise social networking system. Such online enterprise social networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or enterprise social networking systems.

Some online enterprise social networks can be implemented in various settings, including business and organizations. For instance, an online enterprise social network can be implemented to connect users within an enterprise such as a business corporation, partnership or organization, or a group of users within such an enterprise. For instance, Chatter® can be used by employee users in a division of a business organization to share data, communicate, and collaborate with each other for various enterprise-related purposes. In the example of a multi-tenant database system, each organization or group within the organization can be a respective tenant of the system, as described in greater detail below.

In some online enterprise social networks, users can access one or more enterprise network feeds, which include information updates presented as items or entries in the feed. Such a feed item can include a single information update or a collection of individual information updates. A feed item can include various types of data including character-based data, audio data, image data and/or video data. A network feed can be displayed in a graphical user interface (GUI) on a display device such as the display of a computing device as described below. The information updates can include various enterprise social network data from various sources and can be stored in an on-demand database service environment. In some implementations, the disclosed methods, apparatus, systems, and computer-readable storage media may be configured or designed for use in a multi-tenant database environment.

In some implementations, an online enterprise social network may allow a user to follow data objects in the form of records such as cases, accounts, or opportunities, in addition to following individual users and groups of users. The “following” of a record stored in a database, as described in greater detail below, allows a user to track the progress of that record. Updates to the record, also referred to herein as changes to the record, are one type of information update that can occur and be noted on a network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be user-submitted messages or can otherwise be generated in response to user actions or in response to events. Examples of messages include: posts, comments, indications of a user's personal preferences such as “likes” and “dislikes”, updates to a user's status, uploaded files, and user-submitted hyperlinks to enterprise social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some online enterprise social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal network page. One implementation of such a personal network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a network feed displayed on the user's profile page.

In some implementations, a network feed may be specific to a group of enterprise users of an online enterprise social network. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more enterprise users are submitted to a network feed for a particular user, group, object, or other construct within an online enterprise social network, an email notification or other type of network communication may be transmitted to all users following the user, group, or object in addition to the inclusion of the data as a feed item in one or more feeds, such as a user's profile feed, a news feed, or a record feed. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such information update.

In some other implementations, the described enterprise users are not users of an online enterprise social network or social networking system per se. For example, in some other implementations, the enterprise users are simply employees of a business corporation or partnership or are members of an organization that does not have its own social networking system or which does not utilize the services of a third party social network service provider. Such business enterprises and other organizations often use email as their sole or primary means of communicating information to employee users and member users. However, in at least some of the implementations described below, it is contemplated that business enterprises or other organizations could additionally or alternatively use other means of electronic communication, such as, for example, Short Message Service (SMS) messages, Multimedia Messaging Service (MMS) messages, or other text or multimedia messages.

The implementations described or referenced above and below as well as other implementations can be embodied in various types of hardware, software, firmware, or combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

A “user profile” or “user's profile” is generally configured to store and maintain data about a given user of the database system. The data can include general information, such as name, title, phone number, a photo, a biographical summary, and a status, e.g., text describing what the user is currently doing. As mentioned below, the data can include messages created by other users. Where there are multiple tenants, a user is typically associated with a particular tenant. For example, a user could be a salesperson of a company, which is a tenant of the database system that provides a database service.

The term “record” generally refers to a data entity, such as an instance of a data object created by a user of the database service, for example, about a particular (actual or potential) business relationship or project. The data object can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different network feeds. A second user following a first user and a record can receive the feed items associated with the first user and the record for display in the second user's news feed, which is another type of network feed. In some implementations, the feed items from any number of followed users and records can be combined into a single network feed of a particular user.

As examples, a feed item can be a message, such as a user-generated post of text data, and a “feed tracked” update to a record or profile, such as a change to a field of the record. Feed tracked updates are described in greater detail below. A feed can be a combination of messages and feed tracked updates. Messages include text created by a user, and may include other data as well. Examples of messages include posts, user status updates, and comments. Messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a graphical user interface (GUI), for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group. In one implementation, there is only one status for a record.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Messages and feed updates can be stored as a field or child object of the record. For example, the feed can be stored as a child object of the record. Events that have feed tracked updates and/or the selective distributing of feed updates to enterprise users may be optimized based on relevance as described above and as described in more detail below with reference to FIGS. 7-10. In various implementations and applications, it is useful to identify relevant enterprise users to whom to send or display notifications concerning relevant updates, and to avoid sending or displaying notifications concerning updates to other enterprise users to whom the updates are not relevant.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and messages, such as posts, comments, likes, etc., can define group conversations and change over time.

An “entity feed” or “record feed” generally refers to a feed of feed items about a particular record in the database, such as feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” is a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

I. General Overview

Systems, apparatus, and methods are provided for implementing enterprise level social and business information networking Such implementations can provide more efficient use of a database system. For instance, a user of a database system may not easily know when important information in the database has changed, e.g., about a project or client. Implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed right to the manager's feed page or other page.

In some implementations, as described above and as described in more detail below with reference to FIGS. 7-10, once a record update has been made, a feed tracked update about the record update can then be automatically provided to those enterprise users, if any, for which it is determined that the feed tracked update is relevant. This avoids the requirement in subscription distribution models for a user to subscribe to a particular record in order to receive relevant information about the record such as updates to the record. It also reduces or substantially eliminates the possibility that a user receives an irrelevant update. For example, it may be determined that a manager finds relevant only certain relatively important updates to a record while a more junior employee finds relevant, or should receive (based on a desire of enterprise management), more or all updates to the record. Thus, different updates may have different relevance to different employees (this is an example of how a user trait such as employment position can affect which communications are relevant). In some implementations, such relevancy analysis can be used in conjunction with subscription distribution models. For example, although many enterprise users may be subscribed to a particular record or other data object, the updates that are sent or displayed to a relevant subset of those enterprise users can depend on the user traits of the particular subscribed enterprise users. Referring back to the example above, it may be determined that, while both the manager and the junior employee are subscribed to the record, only certain updates are determined to be relevant to the manager and thus, only a relevant subset of the updates are sent or displayed to the manager. Additionally, as already described and as described in detail with reference to FIGS. 7-10, enterprise users that aren't subscribed to the record, but for which it is determined that the update is relevant, can be identified/targeted and the update can then be distributed to these non-subscribed enterprise users as well.

Next, mechanisms and methods for providing systems implementing enterprise level social and business information networking will be described with reference to several implementations. First, an overview of an example of a database system is described, and then examples of tracking events for a record, actions of a user, and messages about a user or record are described. Various implementations about the data structure of feeds, customizing feeds, user selection of records and users to follow, generating feeds, and displaying feeds are also described.

II. System Overview

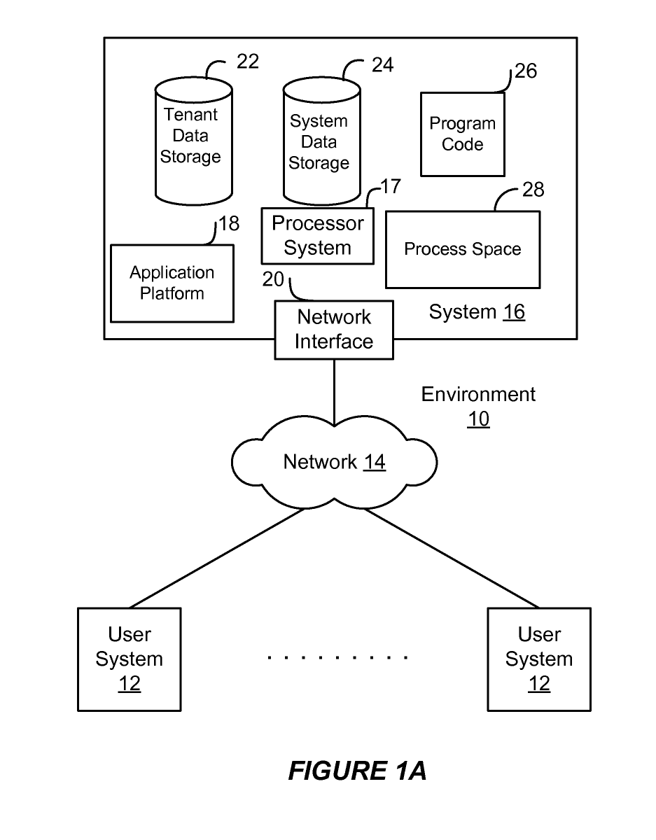

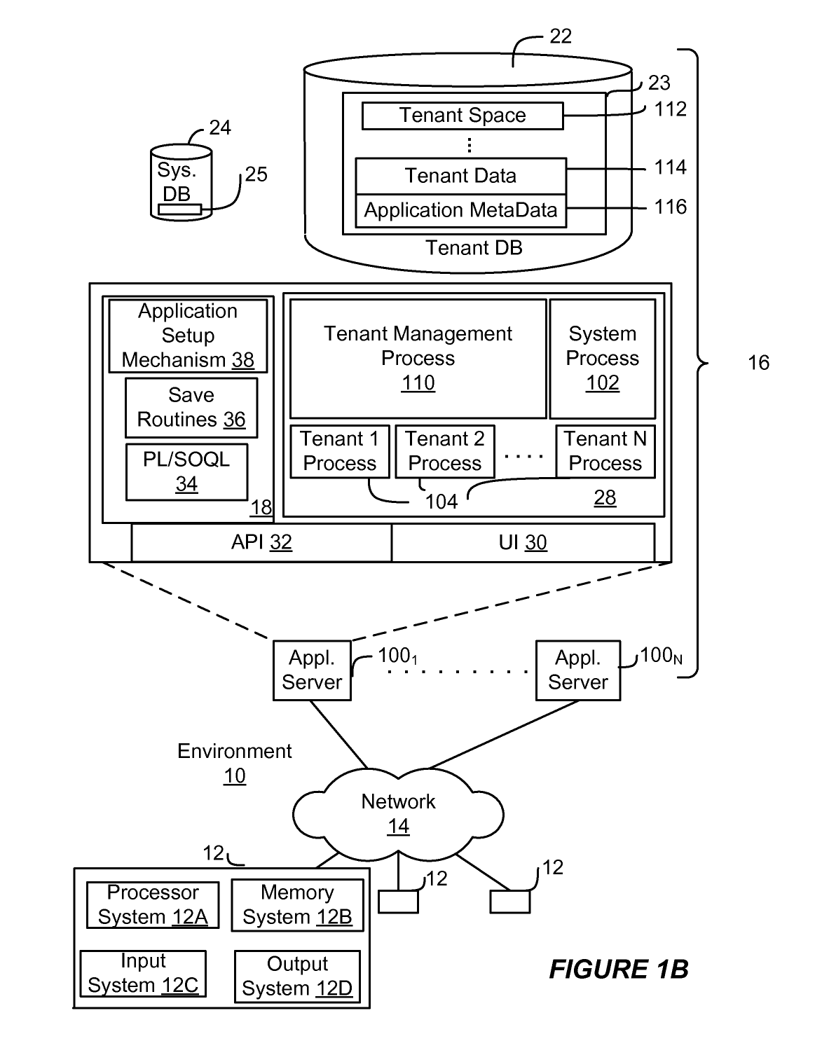

FIG. 1A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In some other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 1A (and in more detail in FIG. 1B) user systems 12 might interact via a network 14 with an on-demand database service, which is implemented in the example of FIG. 1A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to the salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 1A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Web page content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 1A and 1B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes. Additionally, a machine learning system, as described below with reference to FIGS. 7-10, also may execute on the system 16.

Several elements in the system shown in FIG. 1A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 1B shows a block diagram of an example of some implementations of elements of FIG. 1A and various possible interconnections between these elements. That is, FIG. 1B also illustrates environment 10. However, in FIG. 1B elements of system 16 and various interconnections in some implementations are further illustrated. FIG. 1B shows that user system 12 may include processor system 12A, memory system 12B, input system 12C, and output system 12D. FIG. 1B shows network 14 and system 16. FIG. 1B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 100₁-100_{N}, system process space 102, tenant process spaces 104, tenant management process space 110, tenant storage space 112, user storage 114, and application metadata 116. In other implementations, environment 10 may not have the same elements as those listed above and/or may have other elements instead of, or in addition to, those listed above.

User system 12, network 14, system 16, tenant data storage 22, and system data storage 24 were discussed above in FIG. 1A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 1B, system 16 may include a network interface 20 (of FIG. 1A) implemented as a set of HTTP application servers 100, an application platform 18, tenant data storage 22, and system data storage 24. Also shown is system process space 102, including individual tenant process spaces 104 and a tenant management process space 110. Each application server 100, also referred to herein as an “app server”, may be configured to communicate with tenant data storage 22 and the tenant data 23 therein, and system data storage 24 and the system data 25 therein to serve requests of user systems 12. The tenant data 23 might be divided into individual tenant storage spaces 112, which can be either a physical arrangement and/or a logical arrangement of data. Within each tenant storage space 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage space 112. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain implementations, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one implementation, therefore, an interface system implementing a load balancing function (e.g., an F5 Big-IP load balancer) is communicably coupled between the application servers 100 and the user systems 12 to distribute requests to the application servers 100. In one implementation, the load balancer uses a least connections algorithm to route user requests to the application servers 100. Other examples of load balancing algorithms, such as round robin and observed response time, also can be used. For example, in certain implementations, three consecutive requests from the same user could hit three different application servers 100, and three requests from different users could hit the same application server 100. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 100 to request and update system-level and tenant-level data from system 16 that may involve sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

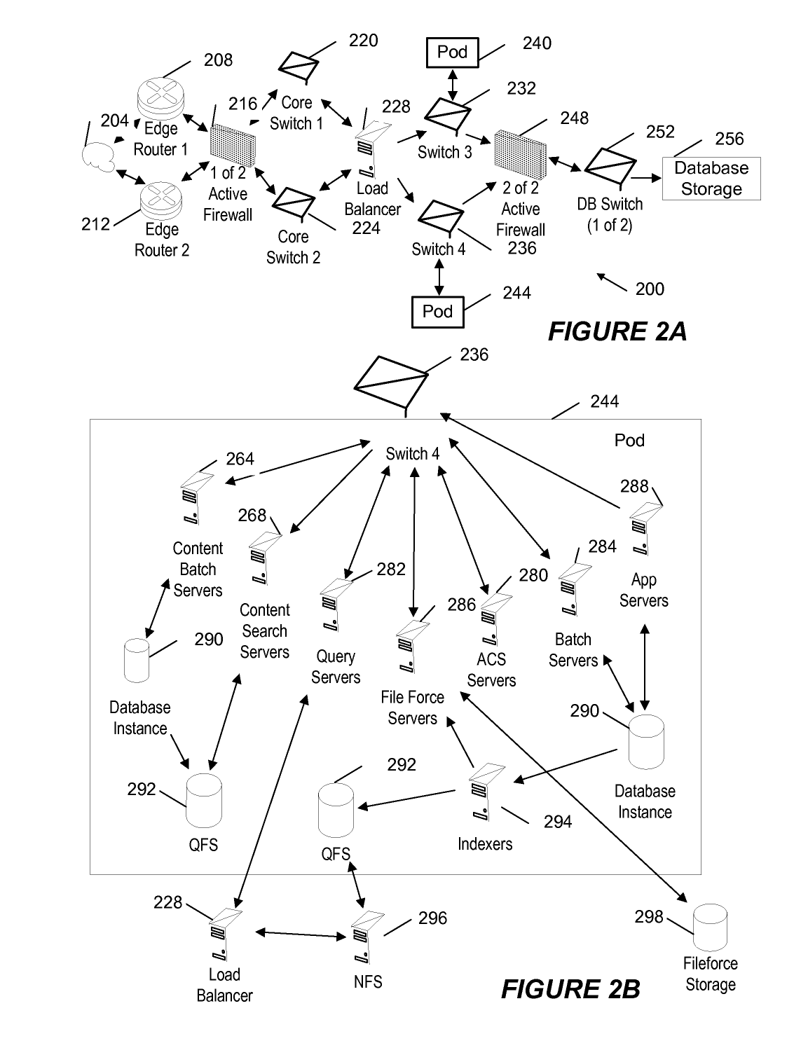

FIG. 2A shows a system diagram illustrating an example of architectural components of an on-demand database service environment 200 according to some implementations. A client machine located in the cloud 204, generally referring to one or more networks in combination, as described herein, may communicate with the on-demand database service environment via one or more edge routers 208 and 212. A client machine can be any of the examples of user systems 12 described above. The edge routers may communicate with one or more core switches 220 and 224 via firewall 216. The core switches may communicate with a load balancer 228, which may distribute server load over different pods, such as the pods 240 and 244. The pods 240 and 244, which may each include one or more servers and/or other computing resources, may perform data processing and other operations used to provide on-demand services. Communication with the pods may be conducted via pod switches 232 and 236. Components of the on-demand database service environment may communicate with a database storage 256 via a database firewall 248 and a database switch 252.

As shown in FIGS. 2A and 2B, accessing an on-demand database service environment may involve communications transmitted among a variety of different hardware and/or software components. Further, the on-demand database service environment 200 is a simplified representation of an actual on-demand database service environment. For example, while only one or two devices of each type are shown in FIGS. 2A and 2B, some implementations of an on-demand database service environment may include anywhere from one to many devices of each type. Also, the on-demand database service environment need not include each device shown in FIGS. 2A and 2B, or may include additional devices not shown in FIGS. 2A and 2B.

Moreover, one or more of the devices in the on-demand database service environment 200 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 204 is intended to refer to a data network or plurality of data networks, often including the Internet. Client machines located in the cloud 204 may communicate with the on-demand database service environment to access services provided by the on-demand database service environment. For example, client machines may access the on-demand database service environment to retrieve, store, edit, and/or process information.

In some implementations, the edge routers 208 and 212 route packets between the cloud 204 and other components of the on-demand database service environment 200. The edge routers 208 and 212 may employ the Border Gateway Protocol (BGP). The BGP is the core routing protocol of the Internet. The edge routers 208 and 212 may maintain a table of IP networks or ‘prefixes’, which designate network reachability among autonomous systems on the Internet.

In one or more implementations, the firewall 216 may protect the inner components of the on-demand database service environment 200 from Internet traffic. The firewall 216 may block, permit, or deny access to the inner components of the on-demand database service environment 200 based upon a set of rules and other criteria. The firewall 216 may act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 may be configured as network bridges that quickly route data between different components within the on-demand database service environment. In some implementations, the use of two or more core switches 220 and 224 may provide redundancy and/or reduced latency.

In some implementations, the pods 240 and 244 may perform the core data processing and service functions provided by the on-demand database service environment. Each pod may include various types of hardware and/or software computing resources. An example of the pod architecture is discussed in greater detail with reference to FIG. 2B.

In some implementations, communication between the pods 240 and 244 may be conducted via the pod switches 232 and 236. The pod switches 232 and 236 may facilitate communication between the pods 240 and 244 and client machines located in the cloud 204, for example via core switches 220 and 224. Also, the pod switches 232 and 236 may facilitate communication between the pods 240 and 244 and the database storage 256.

In some implementations, the load balancer 228 may distribute workload between the pods 240 and 244. Balancing the on-demand service requests between the pods may assist in improving the use of resources, increasing throughput, reducing response times, and/or reducing overhead. The load balancer 228 may include multilayer switches to analyze and forward traffic.

In some implementations, access to the database storage 256 may be guarded by a database firewall 248. The database firewall 248 may act as a computer application firewall operating at the database application layer of a protocol stack. The database firewall 248 may protect the database storage 256 from application attacks such as structure query language (SQL) injection, database rootkits, and unauthorized information disclosure.

In some implementations, the database firewall 248 may include a host using one or more forms of reverse proxy services to proxy traffic before passing it to a gateway router. The database firewall 248 may inspect the contents of database traffic and block certain content or database requests. The database firewall 248 may work on the SQL application level atop the TCP/IP stack, managing applications' connection to the database or SQL management interfaces as well as intercepting and enforcing packets traveling to or from a database network or application interface.

In some implementations, communication with the database storage 256 may be conducted via the database switch 252. The multi-tenant database storage 256 may include more than one hardware and/or software components for handling database queries. Accordingly, the database switch 252 may direct database queries transmitted by other components of the on-demand database service environment (e.g., the pods 240 and 244) to the correct components within the database storage 256.

In some implementations, the database storage 256 is an on-demand database system shared by many different organizations. The on-demand database system may employ a multi-tenant approach, a virtualized approach, or any other type of database approach. An on-demand database system is discussed in greater detail with reference to FIGS. 1A and 1B.

FIG. 2B shows a system diagram further illustrating an example of architectural components of an on-demand database service environment according to some implementations. The pod 244 may be used to render services to a user of the on-demand database service environment 200. In some implementations, each pod may include a variety of servers and/or other systems. The pod 244 includes one or more content batch servers 264, content search servers 268, query servers 282, file force servers 286, access control system (ACS) servers 280, batch servers 284, and app servers 288. Also, the pod 244 includes database instances 290, quick file systems (QFS) 292, and indexers 294. In one or more implementations, some or all communication between the servers in the pod 244 may be transmitted via the switch 236.

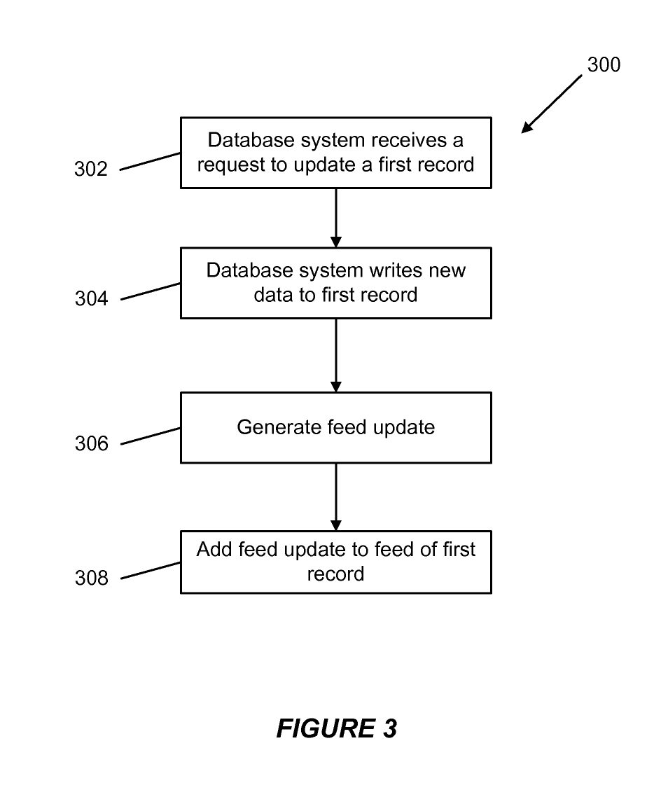

In some implementations, the app servers 288 may include a hardware and/or software framework dedicated to the execution of procedures (e.g., programs, routines, scripts) for supporting the construction of applications provided by the on-demand database service environment 200 via the pod 244. In some implementations, the hardware and/or software framework of an app server 288 is configured to execute operations of the services described herein, including performance of the blocks of methods described with reference to FIGS. 3-10. In alternative implementations, two or more app servers 288 may be included and cooperate to perform such methods, or one or more other servers described herein can be configured to perform the disclosed methods.

The content batch servers 264 may handle requests internal to the pod. These requests may be long-running and/or not tied to a particular customer. For example, the content batch servers 264 may handle requests related to log mining, cleanup work, and maintenance tasks.

The content search servers 268 may provide query and indexer functions. For example, the functions provided by the content search servers 268 may allow users to search through content stored in the on-demand database service environment.

The file force servers 286 may manage requests for information stored in the Fileforce storage 298. The Fileforce storage 298 may store information such as documents, images, and basic large objects (BLOBs). By managing requests for information using the file force servers 286, the image footprint on the database may be reduced.

The query servers 282 may be used to retrieve information from one or more file systems. For example, the query system 282 may receive requests for information from the app servers 288 and then transmit information queries to the NFS 296 located outside the pod.

The pod 244 may share a database instance 290 configured as a multi-tenant environment in which different organizations share access to the same database. Additionally, services rendered by the pod 244 may call upon various hardware and/or software resources. In some implementations, the ACS servers 280 may control access to data, hardware resources, or software resources.

In some implementations, the batch servers 284 may process batch jobs, which are used to run tasks at specified times. Thus, the batch servers 284 may transmit instructions to other servers, such as the app servers 288, to trigger the batch jobs.

In some implementations, the QFS 292 may be an open source file system available from Sun Microsystems® of Santa Clara, Calif. The QFS may serve as a rapid-access file system for storing and accessing information available within the pod 244. The QFS 292 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 268 and/or indexers 294 to identify, retrieve, move, and/or update data stored in the network file systems 296 and/or other storage systems.

In some implementations, one or more query servers 282 may communicate with the NFS 296 to retrieve and/or update information stored outside of the pod 244. The NFS 296 may allow servers located in the pod 244 to access information to access files over a network in a manner similar to how local storage is accessed.

In some implementations, queries from the query servers 222 may be transmitted to the NFS 296 via the load balancer 228, which may distribute resource requests over various resources available in the on-demand database service environment. The NFS 296 may also communicate with the QFS 292 to update the information stored on the NFS 296 and/or to provide information to the QFS 292 for use by servers located within the pod 244.

In some implementations, the pod may include one or more database instances 290. The database instance 290 may transmit information to the QFS 292. When information is transmitted to the QFS, it may be available for use by servers within the pod 244 without using an additional database call.

In some implementations, database information may be transmitted to the indexer 294. Indexer 294 may provide an index of information available in the database 290 and/or QFS 292. The index information may be provided to file force servers 286 and/or the QFS 292.

III. Tracking Updates to a Record Stored in a Database

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know; that is, whose who would find the communication relevant. Accordingly, some implementations of Chatter® can inform others (e.g., co-workers) who want to know about an update to a record automatically.

FIG. 3 shows a flowchart of an example method 300 for tracking updates to a record stored in a database system according to some implementations. Method 300 (and other methods described herein) may be implemented at least partially with multi-tenant database system 16, e.g., by one or more processors configured to receive or retrieve information, process the information, store results, and transmit the results. In other implementations, method 300 may be implemented at least partially with a single tenant database system. In various implementations, blocks may be omitted, combined, or split into additional blocks for method 300, as well as for other methods described herein.

In block 302, the database system receives a request to update a first record. In some implementations, the request is received from a first user. For example, a user may be accessing a page associated with the first record, and may change a displayed field and “click” save. In another implementation, the database system can automatically create the request. For instance, the database system can create the request in response to another event, e.g., a request to change a field could be sent periodically at a particular date and/or time of day, or a change to another field or object. The database system can obtain a new value based on other fields of a record and/or based on parameters in the system.

The request for the update of a field of a record is an example of an event associated with the first record for which a feed tracked update may be created. In other implementations, the database system can identify other events besides updates to fields of a record. For example, an event can be a submission of approval to change a field. Such an event can also have an associated field (e.g., a field showing a status of whether a change has been submitted). Other examples of events can include creation of a record, deletion of a record, converting a record from one type to another (e.g., converting a lead to an opportunity), closing a record (e.g., a case type record), and potentially any other state change of a record—any of which could include a field change associated with the state change. Any of these events update the record whether by changing a field of the record, a state of the record, or some other characteristic or property of the record. In some implementations, a list of supported events for creating a feed tracked update can be maintained within the database system, e.g., at a server or in a database.

In block 304, the database system writes new data to the first record. In some implementations, the new data may include a new value that replaces old data. For example, a field is updated with a new value. In another implementation, the new data can be a value for a field that did not contain data before. In yet another implementation, the new data could be a flag, e.g., for a status of the record, which can be stored as a field of the record.

In some implementations, a “field” can also include records, which are child objects of the first record in a parent-child hierarchy. A field can alternatively include a pointer to a child record. A child object itself can include further fields. Thus, if a field of a child object is updated with a new value, the parent record also can be considered to have a field changed. In one example, a field could be a list of related child objects, also called a related list.

In block 306, a feed tracked update is generated about the update to the record. In some implementations, the feed tracked update is created in parts for assembling later into a display version. For example, event entries can be created and tracked in a first table, and changed field entries can be tracked in another table that is cross-referenced with the first table. In another implementation, the feed tracked update is automatically generated by the database system. The feed tracked update can convey in words that the first record has been updated and provide details about what was updated in the record and who performed the update. In some implementations, a feed tracked update is generated for only certain types of events and/or updates associated with the first record.

In block 308, the feed tracked update is added to a feed for the first record. In some implementations, adding the feed tracked update to a feed can include adding events to a table (which may be specific to a record or be for all or a group of objects), where a display version of a feed tracked update can be generated dynamically and presented in a GUI as a feed item when a user requests a feed for the first record. In another implementation, a display version of a feed tracked update can be added when a record feed is stored and maintained for a record. As mentioned above, in some cases a feed may be maintained for only certain records. In some implementations, the feed of a record can be stored in the database associated with the record. For example, the feed can be stored as a field (e.g., as a child object) of the record. Such a field can store a pointer to the text to be displayed for the feed tracked update.

IV. Tracking Actions of a User

In addition to knowing about events associated with a particular record, it can be helpful for a user to know what a particular user is doing. In particular, it might be desirable or convenient to know what the user is doing without the user having to generate the feed tracked update (e.g., a user submitting a synopsis of what the user has done). Accordingly, implementations can automatically track actions of a user that trigger events, and feed tracked updates can be generated for certain events.

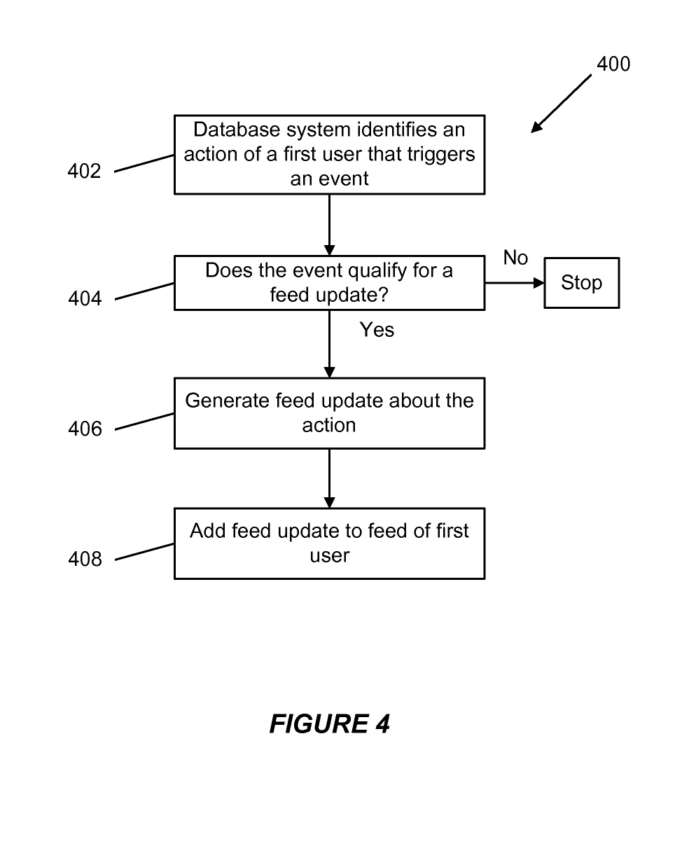

FIG. 4 shows a flowchart of an example method 400 for tracking actions of a user of a database system according to some implementations. The method 400 may be performed in addition to the method 300. The operations of the method 300, including order of blocks, can be performed in conjunction with the method 400 and other methods described herein. Thus, a feed can be composed of changes to a record and actions of users.

In block 402, a database system (e.g., 16 of FIGS. 1A and 1B) identifies an action of a first user. In some implementations, the action triggers an event, and the event is identified. For example, the action of a user requesting an update to a record can be identified, where the event is receiving a request or is the resulting update of a record. The action may thus be defined by the resulting event. In some implementations, only certain types of actions (events) are identified. Which actions are identified can be set as a default or can be configurable by a tenant, or even configurable at a user level. In this way, processing effort can be reduced since only some actions are identified.

In block 404, the system determines whether the event qualifies for a feed tracked update. For example, a predefined list of events (e.g., as mentioned herein) can be created so that only certain actions are identified. As another example, an administrator (or other user) of a tenant can specify the type of actions (events) for which a feed tracked update is to be generated. This block may also be performed for the method 300.

In block 406, a feed tracked update is generated about the action. In an example where the action is an update of a record, the feed tracked update can be similar to or the same as the feed tracked update created for the record. The description can be altered to focus on the user as opposed to the record. For example, “John D. has closed a new opportunity for account XYZ” as opposed to “an opportunity has been closed for account XYZ.” In block 408, the feed tracked update is added to a news feed of the first user.

V. Generation of a Feed Tracked Update

As described above, some implementations can generate text describing events (e.g., updates) that have occurred for a record and actions by a user that trigger an event. A database system can be configured to generate the feed tracked updates for various events in various ways.

In some implementations, the feed tracked update is a grammatical sentence, thereby being easily understandable by a person. In another implementation, the feed tracked update provides detailed information about the update. In various examples, an old value and new value for a field may be included in the feed tracked update, an action for the update may be provided (e.g., submitted for approval), and the names of particular users that are responsible for replying or acting on the feed tracked update may be also provided. The feed tracked update can also have a level of importance based on settings chosen by the administrator, a particular user requesting an update, or by a following user who is to receive the feed tracked update, which fields is updated, a percentage of the change in a field, the type of event, or any combination of these factors.

The system may have a set of heuristics for creating a feed tracked update from the event (e.g., a request to update). For example, the subject may be the user, the record, or a field being added or changed. The verb can be based on the action requested by the user, which can be selected from a list of verbs (which may be provided as defaults or input by an administrator of a tenant). In some implementations, feed tracked updates can be generic containers with formatting restrictions,

As an example of a feed tracked update for a creation of a new record, “Mark Abramowitz created a new Opportunity for IBM—20,000 laptops with Amount as $3.5M and Sam Palmisano as Decision Maker.” This event can be posted to the profile feed for Mark Abramowitz and the entity feed for record of Opportunity for IBM—20,000 laptops. The pattern can be given by (AgentFullName) created a new (ObjectName)(RecordName) with [(FieldName) as (FieldValue) [, /and] ]* [[added/changed/removed] (RelatedListRecordName) [as/to/as] (RelatedListRecordValue) [, /and] ]*. Similar patterns can be formed for a changed field (standard or custom) and an added child record to a related list.

VI. Tracking Commentary from or about a User

As described above, in some implementations, a user can submit user-generated messages including text, instead of or in addition to the database system generating a feed tracked update. As the text is submitted as part or all of a message by a user, the text can be about any topic. Thus, more information than just actions of a user and events of a record can be conveyed. In some implementations, the messages can be used to ask a question about a particular record, and users following the record can provide comments and responses.

In some implementations, all or most feed tracked updates can be commented on. In other implementations, feed tracked updates for certain records (e.g., cases or ideas) are not commentable. In various implementations, comments can be made for any one or more records of opportunities, accounts, contacts, leads, and custom objects. In some implementations, users can rate feed tracked updates or messages (including comments). The order of the feed items displayed on a particular user's, group's or record's page can be based on a relevance value, which can be determined by the database system using various factors as described below with reference to FIGS. 7-10.

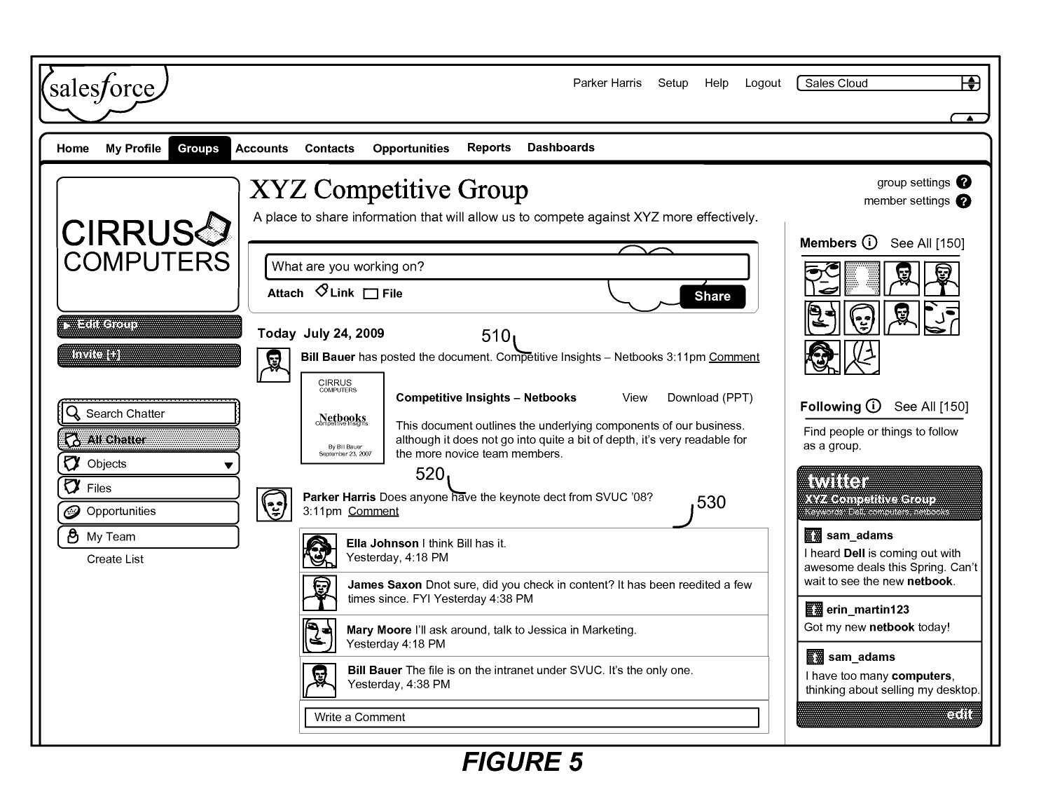

FIG. 5 shows an example of a group feed on a group page according to some implementations. As shown, a feed item 510 shows that a user has posted a document to the group object. The text “Bill Bauer has posted the document Competitive Insights” can be generated by the database system in a similar manner as feed tracked updates about a record being changed. A feed item 520 shows a post to the group, along with comments 630 from Ella Johnson, James Saxon, Mary Moore and Bill Bauer.

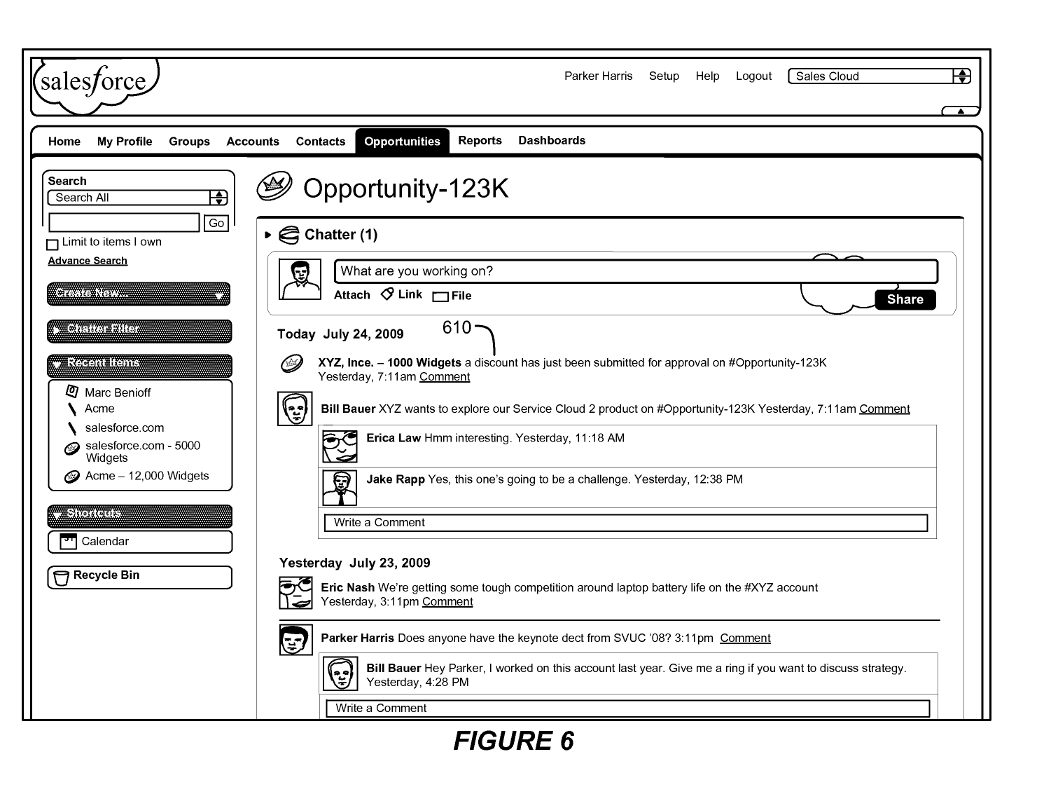

FIG. 6 shows an example of a record feed containing a feed tracked update, post, and comments according to some implementations. Feed item 610 shows a feed tracked update based on the event of submitting a discount for approval. Other feed items show posts, e.g., from Bill Bauer, that are made to the record and comments, e.g., from Erica Law and Jake Rapp, that are made on the posts.

VII. Constructing a Machine Learning Model Useful for Identifying Relevant Enterprise Users Based on a Database of Previously Distributed Communications

FIG. 7 shows a flowchart of an example computer-implemented method 700 for constructing a machine learning model that can be used to identify a target set of relevant enterprise users to which to send or display a communication including enterprise-related information. The method 700 can be performed by any suitable computing device, computing system or any number of computing devices or systems (hereinafter collectively referred to as “the system”) that may cooperate to perform the method 700. In some implementations, each of the blocks of the method 700 can be performed wholly or partially by the database system 16 of FIGS. 1A and 1B, or other suitable devices or components (including processors) described above or the like.

In block 702, the system receives or retrieves a previously distributed communication, or more specifically, information stored in a data object associated with the previously distributed communication. As described above, in various implementations, a user communication can be or can include user-submitted messages such as emails, posts, comments, indications of a user's personal preferences such as “likes” and “dislikes”, updates to a user's status, uploaded files, and hyperlinks or other references to enterprise social network data or other network data such as various documents or web pages accessible via an enterprise's file system, intranet or over the Internet. Additionally or alternatively, in some implementations, the user communication can be or can include automatically-generated messages created and distributed in response to user actions or in response to events. Such automatically-generated user communications may include, for example, record updates, other information updates, software updates, alerts, and other notifications.

In various implementations, the previously distributed communication retrieved in block 702 may be retrieved by a server from, for example, any of a variety of storage mediums as disclosed herein that may be configured to store and maintain communications such as emails, updates or other messages or notifications and related data. For example, tenant data storage 22 and/or system data storage 24 of FIGS. 1A and 1B can store communications and related data. In other examples, any of the various databases and/or memory devices disclosed herein can serve as storage media to store communications that can be retrieved in block 702.

In block 704, the system analyzes the previously distributed communication. For example, the system may analyze one or more of the content of the communication (for example, text in an email, post, comment or update), the purpose or objective of the communication (for example, to notify a user of an update to a record, of an opportunity, or of a software update), the subject of the communication (for example, a particular software program or a particular opportunity), the source of the communication (for example, a particular user, group, record, or other data object) and the recipients of the previously distributed communication. In block 706, the system determines one or more contextual features of the previously distributed communication based on one or more of the content, subject, objective, purpose, source and targets of the communication. For example, contextual features can include context identifiers such as group identifiers, record identifiers and notification identifiers. For example, a contextual feature could include a security identifier associated with a particular level of clearance, a software identifier associated with a particular software program (for example, antivirus software, useful for determining to whom to send antivirus software updates), a hardware identifier associated with particular user hardware (for example, a type, model or brand of computer or phone), an opportunity identifier associated with a particular sales opportunity, a record identifier associated with a particular record or type of record, a job identifier associated with a particular job title or job description, an event identifier associated with a particular notice of a particular event or occurrence, a user identifier associated with a particular enterprise user (for example, a manager or the Chief Executive Officer), a group identifier associated with a particular group (for example, a legal team/department or a marketing team/department), or an identifier associated with a particular idea, among other possible and suitable contextual feature identifiers. In some implementations, the system may analyze text in the communication to search for keywords to determine a contextual feature. The system may also analyze the author or sender of the communication as well as the recipients to determine the contextual feature. In some implementation, a communication can be associated with two or more contextual features.

In block 708, the system identifies or determines one or more relevancy scores for one or more of the respective recipients of the previously distributed communication. In various implementations, each relevancy score can be based on one or more respective actions or one or more inactions (lack of action) taken (or not taken) by the recipient of the previously distributed communication (that is, one or more actions, one or more inactions, or a combination of one or more actions and one or more inactions). In some implementations, a relevancy score can be represented by a numerical value that the system assigns to a particular relevancy indicator, or a combination of relevancy indicators. The relevancy indicators are determined from the one or more actions or inactions taken by the recipient in response to receiving the communication. In some implementations, a relevancy score can be a real number, such as an integer. In some other implementations, a relevancy value can be a real number between, for example, “0” and “1”, inclusive. In some other implementations, a relevancy score can include scores of one or more data types (for example, structured, unstructured or semi-structured data). In some implementations, the system determines a relevancy score for each of the recipients of the previously determined communication. In some other implementations, the system may determine relevancy scores for only a subset of the recipients such as, for example, only those recipients who manifested relatively “strong” or “clear” relevancy indicators, whether positive or negative.

In some implementations, the relevancy indicators are stored at the time the respective actions or inactions are taken by the recipient. In some such implementations, the relevancy indicators are stored as child objects with or linked to a data object representing the communication. In some such implementations, the system retrieves the relevancy indicators for the recipients when it retrieves the communication, and subsequently, determines the relevancy score for each of some or all of the recipients based on the respective relevancy indicators. In some other implementations, the relevancy scores are determined and stored when the associated relevancy indicators are determined. In some such implementations, the database retrieves the relevancy scores for the recipients when it retrieves the communication.

In some implementations, a positive relevancy indicator (or “indication of relevance”) indicates that the recipient found the communication helpful, important, interesting, informative, or otherwise desirable or worth reading, especially from the enterprise's perspective. A positive relevancy indicator could be based on a determination that the recipient actively “clicked” or selected one or more of a “like,” “share,” “bookmark” or other positive feedback indicator button or GUI interactive element presented or displayed in conjunction with the communication when “opened” or viewed by the recipient. In some such implementations, a negative relevancy indicator (or “indication of irrelevance”) could be based on a determination that the recipient actively clicked or selected a “dislike” or other negative feedback indicator button or GUI interactive element presented or displayed in conjunction with the communication. Additionally or alternatively, a positive relevancy indicator could be based on a determination that the recipient opened the communication. Although this may not be that informative as an enterprise user may still open and read a communication but nevertheless find it irrelevant. A negative relevancy indicator could be based on a determination that the recipient marked the communication as read without opening it or deleted the communication without opening it.

Additionally or alternatively, a positive relevancy indicator could be based on a determination that the recipient shared, forwarded, or replied to the communication such as by, for example, forwarding an email, clicking a share button, reposting a communication, or commenting on a feed item. Additionally or alternatively, a positive relevancy indicator could be based on a determination that the recipient bookmarked, archived or otherwise saved the communication or information within the communication. Additionally or alternatively, a relevancy indicator could be based on a determination that the recipient responded to solicited feedback regarding the communication. In some such implementations, whether such a relevancy indicator is positive or negative could depend on the content of the feedback. Additionally or alternatively, a positive relevancy indicator could be based on a determination that the recipient subscribed to or began following a discussion concerning the communication, subscribed to or began following a group discussing the communication, or subscribed to or joined a group to which the communication pertains. In some such implementations, a negative relevancy indicator could be based on a determination that the recipient unsubscribed to or stopped following a discussion concerning the communication, unsubscribed to or stopped following a group discussing the communication, or unsubscribed to or exited a group to which the communication pertains. Additionally or alternatively, determining a relevancy indicator could include performing one or more sentiment analysis techniques to identify a positive or negative user sentiment concerning the communication. Additionally or alternatively, a positive relevancy indicator could be based on a determination that the recipient installed or updated software included within or linked with the communication.

In some implementations, various relevancy indicators may be weighted differently when computing relevancy scores. In some such implementations, relevancy indicators may be weighted based on a data type (for example, structured, unstructured or semi-structured) of the relevancy indicator. For example, in some specific implementations, the act of “sharing” information in a communication may be weighted more heavily than the act of opening or clicking on a communication or a link within a communication. As another example, the act of “liking” a communication may be weighted more heavily than the act of “sharing.” In some implementations, relevancy indicators based on structured data (such as those involving text) can be weighted differently based on the language used by, for example, employing sentient analysis techniques. Additionally or alternatively, in some implementations, relevancy indicators also can be weighted differently based on a contextual identifier. For example, an indication of relevance based on a communication from a relatively important source (such as the Chief Executive Officer, President or General Counsel) can be weighted more heavily than the same type of indication of relevance based on a communication from another relatively less important source (such as a worker in another department).

In block 710, the system identifies one or more user traits and respective user trait values of at least each of those recipients for whom relevancy scores were determined at 708. In some implementations, the user traits can include one or more demographic traits including one or more of: age, gender, race, ethnicity and cultural heritage. For example, if gender is a user trait, then the user trait of gender could have two possible user trait values: male and female. Similarly, if age is a user trait, then the user trait of age could have any number of suitable user trait values; that is, the user trait of age could be divided into any suitable number of suitable sized bins, each of which would have a respective user trait value. For example, one bin may include the ages of 21-30, while another bin could include the ages of 31-40, and another bin could include the ages of 41-50, and so on. In some implementations, the user traits can include one or more psychographic traits including one or more of: personality traits, interests, lifestyle traits and opinions. Again, these user traits can be assigned or subdivided into any suitable number of bins having corresponding representative user trait values. In some implementations, the user traits can include one or more location traits including one or more of: geographic region of residence or work location, state of residence or work location, city of residence or work location, population density, type of business performed at a particular work location, and type of work performed at a particular work location. Again, each user trait can have any suitable number of representative user trait values. In some implementations, the user traits can include one or more employment traits including one or more of: position within employer, title of position, type of position, level within employee management hierarchy, and job responsibility or responsibilities. Again, each user trait can have any suitable number of representative user trait values. In some implementations, the user traits can include one or more technological traits including one or more of: type of computer, type of portable computing device, type of smartphone or other cellular phone, brand of computer or other device, type of operating system, and type of software or software version the user currently has installed. Again, each user trait can have any suitable number of representative user trait values.

In block 712, the system analyzes the one or more contextual features determined in block 706, the one or more relevancy scores determined in block 708 and the one or more user trait values identified in block 710. In block 714, the system constructs or updates a machine learning model based on the analysis. In some implementations, the machine learning model is an n-dimensional statistical model of induction that includes n dimensions for representing n respective user traits, each user trait including two or more possible user trait values or value bins (referred to herein collectively as user trait values). In other terms, the machine learning model can be said to define a vector space having n vectors.

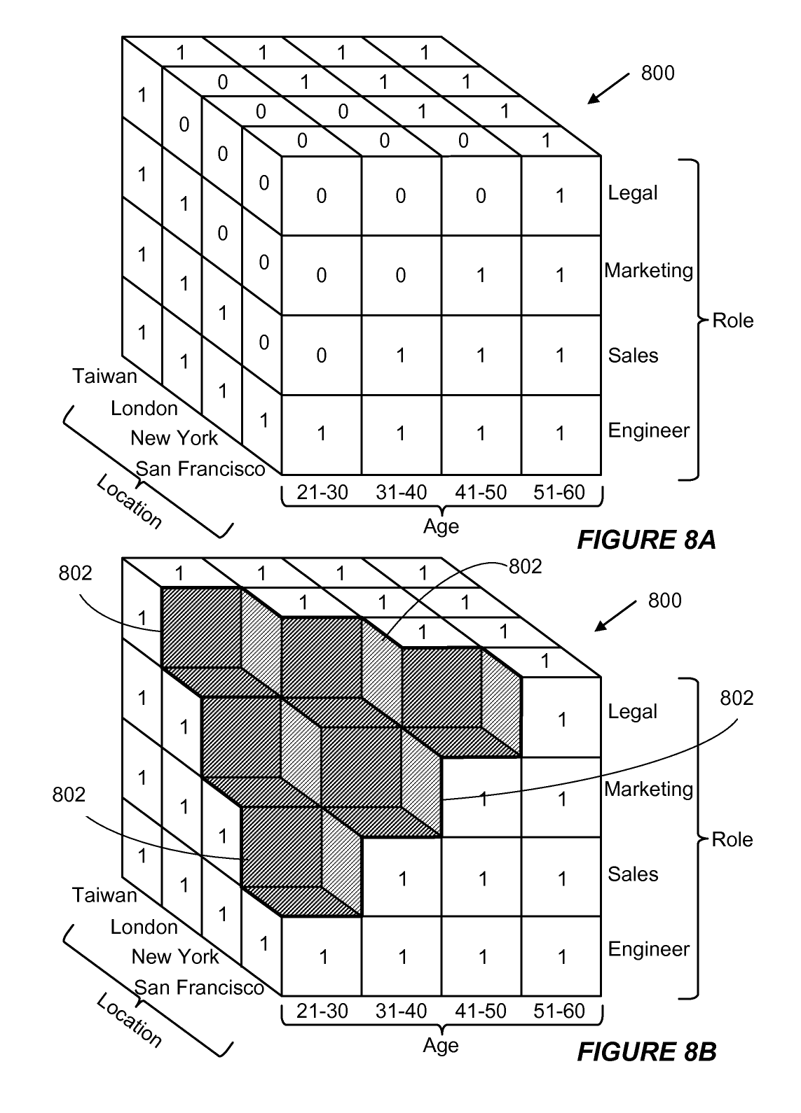

For didactic purposes, FIG. 8A shows a representation of a three-dimensional machine learning model 800. As shown in the example, the machine learning model 800 includes three dimensions for representing three user traits: age, location and role, each having four respective user trait values or bins. For example, the user trait of age has an associated value for each of the age bins of 21-30, 31-40, 41-50 and 51-60. The user trait of location has an associated value for each of the locations of San Francisco, New York, London and Taiwan. And the user trait of role has an associated value for each of the roles of Engineer, Sales, Marketing and Legal. In this simplified representation, each cube in the machine learning model 800 represents a combination of user trait values, and more specifically, a combination of age, location and role values. Continuing with the example, each cube in the machine learning model is further assigned a label for each of one or more contextual features—in this example, a relevancy value having one of two possible values: 0 or 1, where 1 indicates relevance and 0 indicates irrelevance.

In some implementations, constructing or updating the machine learning model includes, for each contextual feature identified in block 706, and for each of one or more user trait values or combinations of user trait values identified in block 710, determining or updating a relevancy value in the machine learning model based on the relevancy score. These relevancy values can then be used as weights in determining the probability that information in a future communication is relevant to a particular user. As described with reference to FIG. 8A, in some implementations, a relevancy value can have one of only two possible values or labels. For example, a relevancy value of “1” can indicate relevance and a relevancy value of “0” can indicate irrelevance. In some other implementations, a relevancy value can have several possible values (for example, real numbers between “0” and “1” inclusive) and may include data of one or more data types (for example, structured, unstructured or semi-structured data). For example, a relevancy value of “1” may indicate the highest level of relevancy, “0” may indicate complete irrelevance (the lowest level of relevance), and values in between may indicate intermediate levels of relevance. In some implementations, the relevancy value could simply be the relevancy score. In some implementations, if there is already a relevancy value associated with a respective contextual feature and a respective user trait value or combination of user trait values, then the existing relevancy value is updated based on the newly determined relevancy score. For example, in some such implementations, the relevancy value stored in the machine learning model is a composite, such as a sum, of the relevancy scores (or relevancy values derived from such relevancy scores) determined for each of the previously analyzed communications (for example, for each of the recipients of the previously analyzed communications for which a relevancy indicator was determined). The machine learning model can be stored in, for example, tenant data storage 22 or system data storage 24 of FIGS. 1A and 1B. In other examples, any of the various databases and/or memory devices disclosed herein can serve as storage media to store the machine learning model.

In block 716, the system determines one or more decision boundaries or updates one or more existing decision boundaries in the machine learning model based on the one or more contextual features, the one or more user trait values, and the one or more relevancy values determined when updating the machine learning model in block 714. Generally, in a statistical-classification problem with two classes, a decision boundary or decision surface is a hypersurface that partitions the underlying vector space into two sets, one for each class. The classifier will classify all the points on one side of the decision boundary as belonging to one class and all those on the other side as belonging to the other class.

In some implementations, each decision boundary is associated with a particular respective contextual feature. Each decision boundary crosses one or more of the n dimensions and, in so doing, distinguishes a respective first set of users (or user trait values or combinations of user trait values) having respective relevancy values above a first threshold from a respective second set of users (or user trait values or combinations of user trait values) having respective relevancy values below the first threshold. Continuing the example described with reference to FIG. 8A, a threshold value of 0.5 could be used. In other words, the system determines each decision boundary such that it maximizes the ability to separate all or a subset of the n dimensions for a given input (for example, for a given contextual feature) to separate the entire set of enterprise users into a first set to whom the information in the communication is likely relevant from a second set to whom the information in the communication is likely irrelevant.

In the context of the simplified example described with reference to FIG. 8A, a decision boundary would separate the machine learning model 800 into two classes: a first class including those combinations of age, location and role for which there is a relevancy value of 1 and a second class including those combinations of age, location and role for which there is a relevancy value of 0. FIG. 8B shows, for didactic purposes, a representation of a decision boundary 802 (shown shaded with diagonal lines) that separates the two classes in the machine learning model 800 of FIG. 8A for a given contextual feature.

In block 718, the system determines whether there are any more previously distributed communications remaining to be analyzed. If it is determined in block 718 that there is at least one remaining communication to be analyzed, then the method proceeds back to block 702 with retrieving a next communication from storage. Else, if it is determined in block 718 that there are no more remaining communications to be analyzed, then, in some implementations, the method 700 proceeds in block 720 with determining, calculating or otherwise generating one or more predicated relevancy values for one or more respective contextual features and respective user trait values or combinations of user trait values. In some such implementations, the predicted relevancy values are based on the decision boundaries determined in block 716 (over one or more iterations of the method 700). In this way, even for those users (or user trait values or combinations of user trait values) for which no actual relevancy data exists, a target set of enterprise users can be identified based on a contextual feature and the predicted relevancy values for such users (or user trait values or combinations of user trait values). In some implementations, the method then ends.

In some implementations, one or more of the blocks of the method 700 can be performed at least partially by, or using, a machine learning system. In various implementations, at least portions of block 712 (including the analysis of the contextual features, the relevancy scores and the user trait values), block 714 (including the construction and updating of the machine learning model), block 716 (including the determination of the decision boundaries), and block 720 (including determining one or more predicted relevancy values), are performed by a machine learning system. For example, in some implementations, the machine learning system can be a subsystem of the database system 16 including a machine learning algorithm executing in the database system 16. In some other implementations, the apparatus or systems described above can utilize a third-party provider to provide the services of a machine learning system. In various implementations, the machine learning system is more particularly a supervised or semi-supervised machine learning system such as, for example, an active machine learning system.

Active learning is a special case of semi-supervised machine learning in which a learning algorithm is able to interactively query an information source to obtain the desired outputs at new data points. In the context of various implementations, the information source(s) the active machine learning system is indirectly querying is/are the recipients of the communications; that is, the relevancy indicators are the information sources for the relevancy values. In this way, the active machine learning system can learn what data is most desirable to train the machine learning model on based on the relevancy indicators from the most recent actions or inactions. Some examples of machine learning techniques suitable for use in certain implementations involve one or more of: decision trees, k-Nearest Neighbors (k-NN) algorithms, linear regression techniques, logistic regression techniques, naive Bayes classifiers, neural networks, perceptrons, support vector machines (SVMs), and multi-arm contextual bandit models.

Additionally, at least because enterprises and enterprise networks can be dynamic entities having changing communication needs, different employees or other enterprise users at different times, employees or other enterprise users having different positions or titles or responsibilities at different times, or enterprise users having different needs at different times, in some implementations, the system can automatically update the machine learning model. For example, the machine learning model can be automatically updated by the machine learning system according to the changing relevance of information to certain user traits to ensure that the machine learning model includes accurate relevancy values and decision boundaries for the various combinations of current user trait values associated with the current set of users belonging to the enterprise or enterprise network.

In some implementations in which an offline machine learning system is used, the machine learning system can automatically update the machine learning model when, for example, it is determined that the relevancy values are no longer valid or reliable. For example, based on relevancy scores indicating a lack of relevance ascertained from a number of predicted relevant enterprise users for a number of communications over a sufficient period of time, the system may determine that the relevancy values in the machine learning model need to be updated. The machine learning system can then be used to update the machine learning model until, for example, all or a subset of the communications sent since the machine learning model construction or the last machine learning model update are processed. In some other implementations, the machine learning system can be used to update the machine learning model until a desired level of confidence in the relevancy values or in the machine learning model overall is achieved.

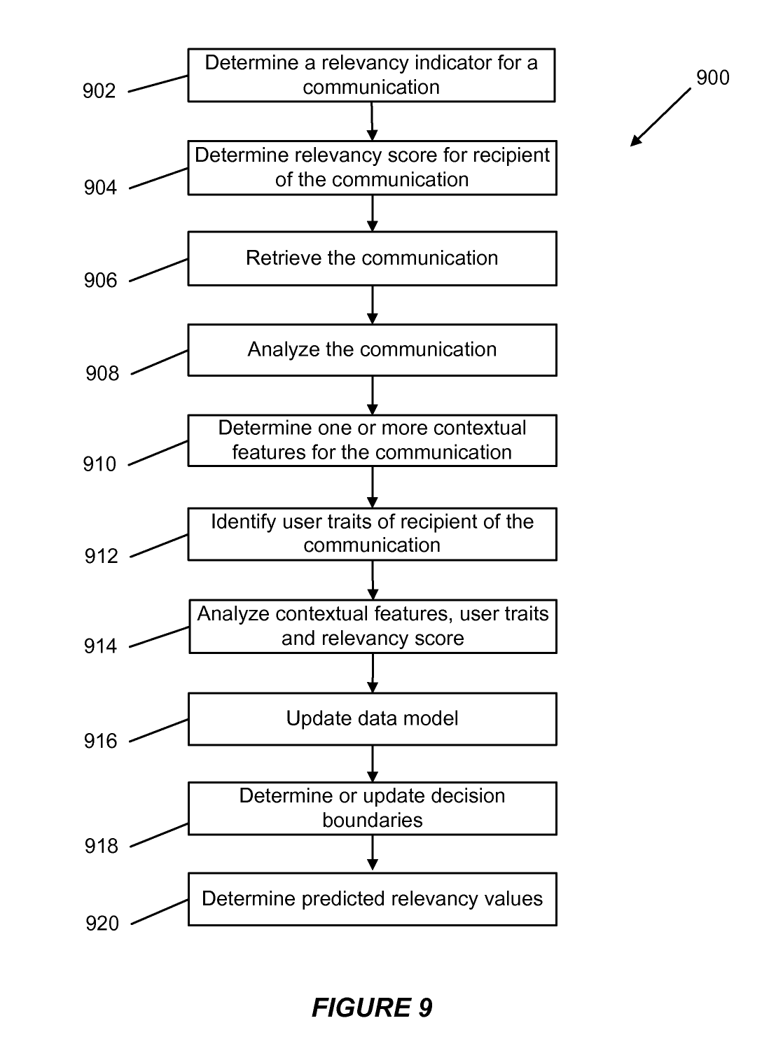

In implementations using an online machine learning system, such analysis and updating as just described can be performed in substantially real time for each communication after it is sent or otherwise displayed or as one or more relevancy indicators or relevancy scores are determined for the communication based on actions or inactions by the recipients. Some implementations of how such updating can be performed are described below with reference to the flowchart of FIG. 9. Online machine learning is a model of induction that continues to learn one instance at a time. The general goal in online learning is to continuously refine a model that predicts labels for instances. For example, in the current context, the labels can be the relevancy values and the instances could describe particular combinations of user trait values or combinations of user trait values for a given contextual feature or combination of contextual features. A defining characteristic of online learning is that after a prediction is made (such as a relevancy value), the true label of the instance can be discovered. For example, the true label for the instance can be discovered by, for example, determining whether a user that was targeted to receive a communication (because the user has a combination of user trait values associated with a relevancy value above a threshold) actually found the communication relevant. This information can then be used to refine the machine learning model (for example, the relevancy values and decision boundaries) used by the online machine learning system with the goal being to generate relevancy values that are close to the true labels.

More specifically, an online machine learning system generally proceeds in a sequence of trials. Each trial can be decomposed into three steps: first, the algorithm receives an instance; second, the algorithm predicts a label for the instance; and third, the algorithm ascertains the true label of the instance. The third stage is the informative stage because the machine learning system can use this label feedback to update its hypothesis for future trials (for example, which enterprise users to target future communications).

In the present context, an active machine learning system can target certain sets of enterprise users to receive communications in an optimal way so as to learn what data is most desirable to train the machine learning model on based on the relevancy indicators from the most recent actions or inactions. In this way, specific sets of enterprise users can be targeted to receive communications and, subsequently, relevancy values are labeled based on actual relevancy scores obtained after such enterprise users receive the communications, to update the machine learning model to maximize the machine learning model's ability to discriminate or distinguish between relevant and irrelevant enterprise users for future communications. Again, some implementations of how such updating can be performed are described below with reference to the flowchart of FIG. 9. The goal is to train the machine learning model sufficiently such that the machine learning model has generalized the problem (of targeting relevant communications) to the entire population of enterprise users (for example, the entire enterprise or enterprise social network) including those enterprise users for which the machine learning has not received actual relevancy data so that accurate predictions can be made as to which enterprise users of the entire population of enterprise users to target future communications.

As described above, it is important to not overgeneralize relevancy indicators so as to avoid sending irrelevant communications to enterprise users. That is, it is important to avoid matching relevancy indicators to user traits for which there is no correlation. Thus, it can be desirable to obtain negative relevancy indicators to avoid the possibility of overgeneralization. To this end, some implementations include an initial training phase for updating the machine learning model in which the system distributes a communication to those enterprise users determined to find the information in the communication highly relevant (for example, the members of the Laptop group in the security announcement example concerning cable locks described above). As another example, a communication concerning an opportunity can be distributed to all enterprise users who are members of or subscribed to a particular record associated with the opportunity. The system then determines relevancy values based on the actions or inactions taken by these highly relevant enterprise users as described above in method 700. Subsequently, when a similar communication is to be distributed, the system then distributes the communication to a broader set of enterprise users including those other enterprise users that are predicted to find the information in the communication less highly relevant but still relevant as well as potentially enterprise users who will likely find the information irrelevant. For example, continuing the example just described, when a subsequent communication concerning the opportunity is to be distributed, the system distributes the communication concerning the opportunity to not just those of the subscribed enterprise users who found the communication relevant, but also to the other enterprise users in the broader set, such as, for example, various managers or department heads (e.g., accounting or marketing heads) or enterprise users who subscribe to or have subscribed to other similar opportunities. The system then determines relevancy values based on the actions or inactions taken by these enterprise users. Subsequently, when another communication concerning the opportunity is to be distributed, the system may then distribute the communication to an ever broader set of enterprise users (if, for example, not enough negative relevancy indicators were determined), or in some cases, a narrower set of enterprise users determined to find the information more relevant (if, for example, too many negative relevancy indicators were determined). This training phase may be repeated until a level of confidence in the machine learning model is achieved. For example, a level of confidence can be estimated by analysis of the relevancy scores determined for the relevancy indicators determined based on the enterprise users' actions or inactions in response to the communications over a number of iterations of similar communications.

Additionally or alternatively, in some implementations, the system may start with a broad set of targeted enterprise users to receive a communication and subsequently narrow the set that receives similar future communications based on relevancy indicators determined for the enterprise users over a number of iterations.

VIII. Dyamically Updating a Machine Learning Model Useful for Identifying Relevant Enterprise Users Based on Communication Relevance

FIG. 9 shows a flowchart of an example computer-implemented method 900 for updating a machine learning model that can be used to identify a target set of relevant enterprise users to which to send or display a communication including enterprise-related information. For example, the method 900 can be used to update the machine learning model constructed with the method 700. The method 900 can be performed by any suitable computing device, computing system or any number of computing devices or systems (hereinafter collectively referred to as “the system”) that cooperate to perform the method 900. In some implementations, each of the blocks of the method 900 can be performed wholly or partially by the database system 16 of FIGS. 1A and 1B, or other suitable devices or components (including processors) described above or the like. In some implementations, some or all of the blocks of the method 900 are performed using or in conjunction with an online machine learning system.

In block 902, the system determines a relevancy indicator for a communication based on the actions or inactions of a recipient to whom the communication was distributed. In some implementations, the system determines and stores the relevancy indicator at the time the respective actions or inactions are taken or detected by the recipient. In some such implementations, the relevancy indicator is stored as a child object with or linked to a data object representing the communication from which it is based. In block 904, the system determines a relevancy score based on the respective relevancy indicator and associates the relevancy score with the respective recipient. As described above, in some implementations, a relevancy score can be represented by a numerical value that the system assigns to a particular relevancy indicator, or a combination of relevancy indicators, determined from one or more actions and/or one or more inactions taken by the recipient in response to receiving the communication. In some implementations, a relevancy score can have one of only two possible values or labels. For example, a relevancy score of 1 can indicate relevance and a relevancy score of 0 can indicate irrelevance. In some other implementations, a relevancy score can have several possible values and may include scores of one or more data types (for example, structured, unstructured or semi-structured). For example, a relevancy score of 1 may indicate the highest level of relevancy, 0 may indicate complete irrelevance (the lowest level of relevance), and scores in between may indicate intermediate levels of relevance.

In some implementations, in block 906, the system retrieves the respective communication or data from the communication, such as the content (including, for example, text or other data in the communication including in attachments), the subject, or the source or targets of the communication. The communication retrieved in block 906 may be retrieved by a server from, for example, any of a variety of storage mediums as disclosed herein that may be configured to store and maintain communications such as emails, updates or other messages or notifications and related data. For example, tenant data storage 22 or system data storage 24 of FIGS. 1A and 1B can store communications and related data. In other examples, any of the various databases and/or memory devices disclosed herein can serve as storage media to store communications that can be retrieved in block 906.

In block 908, the system analyzes the communication. For example, the system may analyze one or more of the content of the communication (for example, text in an email, post, comment or update), the subject of the communication (for example, a particular software program or a particular opportunity), the purpose or objective of the communication (for example, to notify a user of an update to a record, of an opportunity, or of a software update), the source of the communication (for example, a particular user, group, record, or other data object) and the target recipients of the communication. In block 910, the system determines one or more contextual features for the communication based on one or more of the content, subject, purpose, objective, source and targets of the communication as, for example, described above in block 706 of method 700. For example, the system may analyze text in the communication to search for keywords to determine a contextual feature. The database system may also analyze the author or sender of the communication as well as the recipients to determine the contextual feature. In some implementation, a communication can be associated with two or more contextual features. In some other implementations, the system determines the contextual feature(s) for the communication when the communication is sent and stores the contextual feature(s) for subsequent retrieval when the relevancy indicator is determined at 902.

In block 912, the system identifies one or more user traits and respective user trait values of the respective recipient for whom the relevancy score was determined at 904. In some implementations, the user traits can include any of those described above. In block 914, the system analyzes the one or more contextual features determined in block 910 (or previously determined contextual features retrieved from storage), the one or more relevancy scores determined in block 904 and the one or more user trait values identified in block 912. In block 916, the system updates an n-dimensional machine learning model based on the analysis. As described above, in some implementations, the machine learning model includes n dimensions for representing n respective user traits, each user trait including two or more possible user trait values as described above. As described above, the system includes a machine learning system that learns or trains on the contextual features, the relevancy scores and the user trait values to update the machine learning model with the most accurate labels—the relevancy values. Said another way, the machine learning model evaluates the relevancy scores against the contextual features and user trait values to determine the relevancy values for various combinations of contextual features and user trait values. As described above, such relevancy values can then be used as weights in weighting functions to calculate or estimate probabilities for respective users that indicate whether information to be distributed in a future communication is relevant to the users. The machine learning model can be stored in, for example, tenant data storage 22 or system data storage 24 of FIGS. 1A and 1B. In other examples, any of the various databases and/or memory devices disclosed herein can serve as storage media to store the machine learning model.

In some implementations, updating the machine learning model includes, for each contextual feature (or for the combination of contextual features) identified in block 910, and for each of one or more user trait values or combinations of user trait values identified in block 912, determining or updating a relevancy value based on the relevancy score. In some implementations, a relevancy value can have one of only two possible values or labels. For example, a relevancy value of 1 can indicate relevance and a relevancy value of 0 can indicate irrelevance. In some other implementations, a relevancy value can have several possible values and may include data of one or more data types (for example, structured, unstructured or semi-structured). For example, a relevancy value of 1 may indicate the highest level of relevancy, 0 may indicate complete irrelevance (the lowest level of relevance), and values in between may indicate intermediate levels of relevance. In some implementations, the relevancy value could simply be the relevancy score. In some implementations, if there is already a relevancy value associated with a respective contextual feature and a respective user trait value or combination of user trait values, then the existing relevancy value is updated based on the newly determined relevancy score. For example, in some such implementations, the relevancy value stored in the machine learning model can be a composite, such as a sum, of the relevancy scores (or relevancy values derived from such relevancy scores) determined for each of the previously analyzed communications (for example, for each of the recipients of the previously analyzed communications for which a relevancy indicator was determined).

In some implementations, various relevancy scores may be weighted differently when computing relevancy values. For example, in some implementations, relevancy scores can be weighted differently based on a contextual identifier associated with the relevancy score. For example, a relevancy score associated with a communication from a relatively important source (such as the Chief Executive Officer, President or General Counsel) can be weighted more heavily than the same relevancy score when associated with a communication from another relatively less important source (such as a worker in another department).

In block 918, the system determines one or more decision boundaries or updates one or more existing decision boundaries for the machine learning model based on the one or more contextual features, the one or more user trait values, and the one or more relevancy values determined when updating the machine learning model in block 916. In some implementations, each decision boundary is associated with a particular respective contextual feature. Each decision boundary crosses one or more of the n dimensions and, in so doing, distinguishes a respective first set of users (or user trait values or combinations of user trait values) having respective relevancy values above a first threshold from a respective second set of users (or user trait values or combinations of user trait values) having respective relevancy values below the first threshold. Again, in other words, the system determines each decision boundary such that it maximizes the ability to separate all or a subset of the n dimensions for a given input (for example, for given contextual feature) to separate enterprise users to whom similar communications would be relevant from enterprise users to whom such similar communications would be irrelevant.

In some implementations, the method 900 proceeds in block 920 with determining, calculating or otherwise generating one or more predicated relevancy values for one or more respective contextual features and respective user trait values or combinations of user trait values. In some such implementations, the predicted relevancy values are based on the decision boundaries determined in block 918. In some implementations, the method then ends, or waits until another action (or inaction) is detected whereupon the method proceeds back to block 902.

Again, in some implementations, one or more of the blocks of the method 900 can be performed at least partially by, or using, a machine learning system. In various implementations, at least portions of block 914 (including the analysis of the contextual features, the relevancy scores and the user trait values), block 916 (including the updating of the machine learning model), block 918 (including the determination of the decision boundaries), and block 920 (including determining the predicted relevancy values), are performed by a machine learning system, and more specifically, an online machine learning system.

For didactic purposes, as a relatively simple example of the method 900, consider that a communication concerning a software update is distributed to all enterprise users who have an employer-owned computer. The system then determines or updates the relevancy values in the machine learning model based on the actions or inactions taken by these enterprise users as described above in method 900, for example, based on whether such enterprise users installed the software update. Suppose that the relevancy indicators indicate that only a certain brand of laptop enterprise users installed the update, and more specifically, only those enterprise users out of the New York office of an enterprise. This may be the result, for example, if only a particular New York division of an enterprise uses that particular software, and additionally, if the update is only necessary for certain laptop computers. In such a case, a contextual feature could identify the particular software, a first user trait could be a type of hardware (laptop), a second user trait could be a brand/maker of hardware, and a third user trait could be a geographic region or office location. In such a case, the machine learning system can create or update a decision boundary that crosses at least three dimensions (the three user traits just described) to distinguish those enterprise users who find the such information relevant—those enterprise users having laptops of the particular brand working out of the New York office. In this way, when a subsequent update for the software is to be distributed, the system can use the updated decision boundary to identify a target set of enterprise users to receive the update that includes, for example, only those enterprise users in the New York office that use laptops of the particular brand.

Ix. Using a Machine Learning Model to Identify a Target Set of Relevant Enterprise Users to Receive a Communication

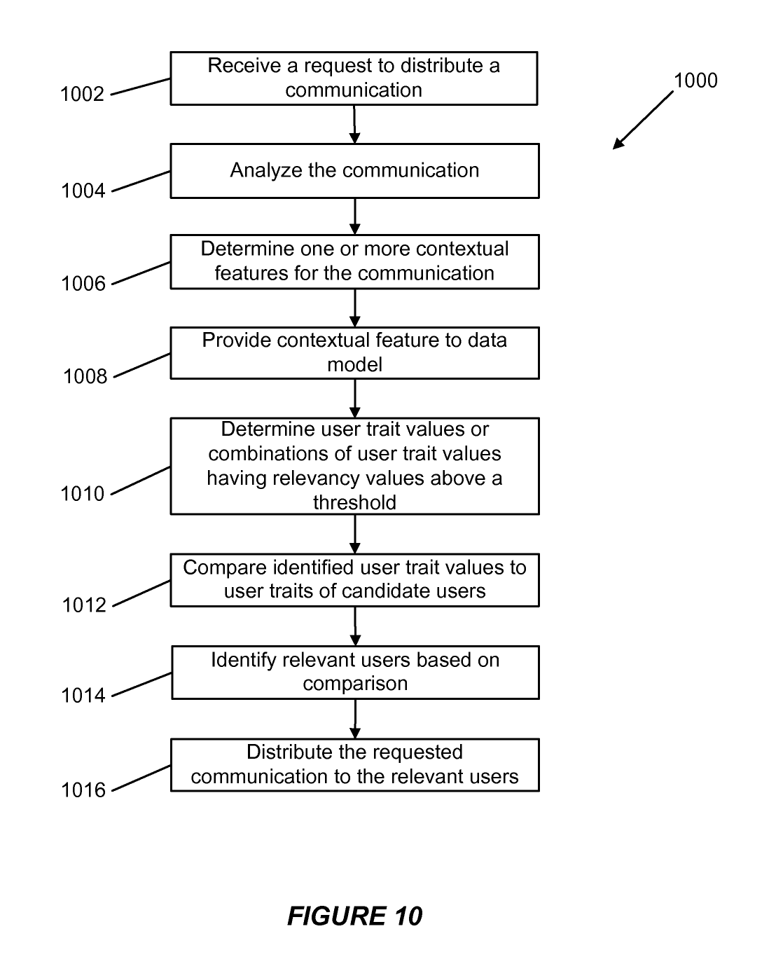

FIG. 10 shows a flowchart of an example computer-implemented method 1000 for using a machine learning model to identify a target set of relevant enterprise users to which to send or display a communication. For example, the method 1000 can be used to identify a target set of relevant enterprise users based on the machine learning model constructed with the method 700 or updated with the method 900. The method 1000 can be performed by any suitable computing device, computing system or any number of computing devices or systems (hereinafter collectively referred to as “the system”) that cooperate to perform the method 1000. In some implementations, each of the blocks of the method 1000 can be performed wholly or partially by the database system 16 of FIGS. 1A and 1B, or other suitable devices or components (including processors) described above or the like.

In block 1002, the system receives a request to distribute a communication. For example, the request to distribute a communication can be based on the detection of an event. In some implementations, the request to distribute a communication received in block 1002 is received in response to the generation of a feed tracked update about an update to a record, such as that generated in block 306 of the method 300 shown in FIG. 3. Additionally or alternatively, in some implementations, the request to distribute a communication received in block 1002 is received in response to the generation of a feed tracked update about an action, such as that generated in block 406 of the method 400 shown in FIG. 4. As described above, for example, one or more processors or processing systems can identify an event that meets criteria for a feed tracked update, and then generate the feed tracked update. The processor also can identify a message. For example, an application interface can have certain mechanisms for submitting a message (e.g., “submit” buttons on a profile page, detail page of a record, “comment” button on post), and use of these mechanisms can be used to identify a message to be added to a table used to create a feed for display.

In block 1004, the system analyzes the communication, or if the communication has not yet been generated, the information to be conveyed by the communication. For example, the system may analyze one or more of the content of the communication (for example, text in an email, post, comment or update), the subject of the communication (for example, a particular software program or a particular opportunity), the purpose or objective of the communication (for example, to notify a user of an update to a record, of an opportunity, or of a software update) or the source of the communication (for example, a particular user, group, record, or other data object). In block 1006, the system determines one or more contextual features for the communication based on one or more of the content, subject, purpose, objective and source of the communication as, for example, described above in block 706 of the method 700 and block 910 of the method 900. For example, the system may analyze text in the communication (or in an attachment such as a document) to search for keywords to determine a contextual feature. The database system may also analyze the author or sender of the communication to determine the contextual feature. In some implementation, a communication can be associated with two or more contextual features.

In block 1008, the system provides the one or more contextual features determined in block 1006 to an n-dimensional machine learning model. As described above, the machine learning model can include n dimensions for representing n respective user traits, each user trait having two or more possible values. The machine learning model further includes relevancy values and decision boundaries as described above. In some implementations, each decision boundary is associated with a particular respective contextual feature. Each decision boundary crosses one or more of the n dimensions and, in so doing, distinguishes a respective first set of users (or user trait values or combinations of user trait values) having respective relevancy values above a first threshold from a respective second set of users (or user trait values or combinations of user trait values) having respective relevancy values below the first threshold. Again, in other words, the system determines each decision boundary such that it maximizes the ability to separate all or a subset of the n dimensions for a given input (for example, for given contextual feature) to separate enterprise users to whom similar communications would be relevant from enterprise users to whom such similar communications would be irrelevant. As described above, the machine learning model can be stored in, for example, tenant data storage 22 or system data storage 24 of FIGS. 1A and 1B. In other examples, any of the various databases and/or memory devices disclosed herein can serve as storage media to store the machine learning model.

In some implementations, in block 1010, the system determines, based on one or more respective decision boundaries in the machine learning model for the one or more contextual features determined in block 1006, those user trait values or combinations of user trait values having relevancy values above the threshold. In block 1012, these identified user trait values or combinations of user trait values can then be compared with the user traits and respective values of a plurality of respective candidate enterprise users (for example, all enterprise users or all users of an enterprise social network) to identify, in block 1014, the relevant enterprise users of the larger set of candidate enterprise users.

As described above, in some other implementations blocks 1010, 1012 and 1014 can be combined into a single block or otherwise modified. For example, in some implementations, the machine learning model includes the identities or identifiers for the enterprise users and links between the user identifiers and their respective user trait values. In some such implementations, the machine learning model outputs a set of probabilities for all of the candidate enterprise users that indicate the likely relevance of the communication to the users based on the contextual features of the communication. In some implementations, enterprise users having probabilities of relevance above a threshold are selected to receive the communication.

In still other such implementations, the decision boundaries are generated to separate users (as opposed to user trait values). And in some such implementations, the machine learning model can output the identities or user identifiers themselves associated with those enterprise users, as opposed to outputting the probabilities associated with such users and as opposed to outputting probabilities associated with user trait values that then have to be compared with user traits in a user trait database to identify the relevant enterprise users (as in blocks 1010, 1012 and 1014).

The system can be populated with user trait values for respective enterprise users manually or automatically. For example, in some implementations, the system “crawls” or otherwise searches user data, such as that which may be determined from user profiles as described above, to populate a database of user trait values for the respective enterprise users. In some implementations, these user trait values are stored as child objects of respective user data objects in, for example, tenant data storage 22 or system data storage 24 of FIGS. 1A and 1B. In other examples, any of the various databases and/or memory devices disclosed herein can serve as storage media to store the user trait values.

In block 1016, the system distributes the requested communication to those enterprise users identified in block 1014. In some implementations, distributing the communication includes displaying, or causing to be displayed, the communication in a feed or list of communications associated with the user. Additionally or alternatively, in some implementations, distributing the communication includes sending the communication in an email, an SMS message, an MMS message or other text or multimedia message. In some implementations, the method then awaits another request to distribute a communication.

Again, it should now be appreciated that the actions or inactions taken by the enterprise users identified in block 1014, in response to receiving the communication distributed in block 1016, can then be used to determine relevancy indicators and scores and used by a machine learning system to update relevancy values and decision boundaries in the machine learning model to even better target future communications.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A computer implemented method for updating a machine learning model for determining one or more decision boundaries, the method comprising:
analyzing, by one or more computing systems, an enterprise-related user communication;
determining, by the one or more computing systems, one or more contextual features for the user communication based on one or more of the content, subject, purpose, source, and recipients of the user communication;
determining, by the one or more computing systems, one or more relevancy scores for each of one or more respective recipients of the user communication, each relevancy score based on actions taken or not taken by the respective recipients based on the communication, each relevancy score representing a relevance of enterprise-related information included with the communication to the respective recipient;
determining, by the one or more computing systems, one or more user traits associated with the one or more recipients of the user communication;
analyzing, by a machine learning system executing within the one or more computing systems, the one or more determined contextual features, the one or more determined relevancy scores and the one or more determined user traits associated with the one or more recipients;
updating, by the machine learning system, a machine learning model based on the analysis of the one or more determined contextual features, the one or more determined relevancy scores and the one or more determined user traits, the machine learning model being stored in one or more databases accessible by the one or more computing systems, the updating including determining one or more relevancy values for the machine learning model based at least in part on the one or more determined relevancy scores and the one or more determined user traits; and
determining one or more decision boundaries for the machine learning model based on the determined relevancy values, each decision boundary separating at least a portion of the machine learning model into a first class of user trait values having respective relevancy values above a threshold from a respective second class of user trait values having respective relevancy values below the threshold.

2. The method of claim 1, wherein:
the machine learning model is an n-dimensional model including n dimensions for representing n respective user traits, each user trait including two or more possible user trait values; and
each decision boundary is associated with one or more respective contextual features and crosses one or more of the n dimensions.

3. The method of claim 1, wherein updating the machine learning model includes:
calculating one or more predicted relevancy values for one or more respective combinations of one or more contextual features and one or more respective user trait values or combinations of user trait values; and
adding the predicted relevancy values to the machine learning model.

4. The method of claim 1, wherein determining the relevancy score for the user communication includes identifying a relevancy indicator for the user communication based on one or more respective actions or inactions of a respective one of the recipients of the user communication.

5. The method of claim 4, wherein identifying a relevancy indicator includes determining whether the recipient actively clicked or selected one or more of a “like,” “share,” “bookmark” or other positive feedback indicator button or GUI interactive element presented or displayed in conjunction with the user communication.

6. The method of claim 4, wherein identifying a relevancy indicator includes determining whether the recipient actively clicked or selected one or more of a “dislike” or other negative feedback indicator button or GUI interactive element presented or displayed in conjunction with the user communication.

7. The method of claim 4, wherein identifying a relevancy indicator includes determining one or more of whether the recipient opened the user communication, marked the user communication as read without opening it, or deleted the user communication without opening it.

8. The method of claim 4, wherein identifying a relevancy indicator includes determining one or more of whether the recipient shared, forwarded, or replied to the user communication.

9. The method of claim 4, wherein identifying a relevancy indicator includes determining one or more of whether the recipient bookmarked, archived, otherwise saved the user communication or information within the user communication.

10. The method of claim 4, wherein identifying a relevancy indicator includes determining one or more of whether or how the recipient responded to solicited feedback regarding the user communication.

11. The method of claim 4, wherein identifying a relevancy indicator includes determining one or more of whether the recipient began following a discussion concerning the user communication, subscribed to a group discussing the user communication, subscribed to a group to which the user communication pertains, stopped following a discussion concerning the user communication, unsubscribed to a group discussing the user communication, or unsubscribed to a group to which the user communication pertains.

12. The method of claim 4, wherein identifying a relevancy indicator includes performing one or more sentiment analysis techniques to identify a positive or negative user sentiment concerning the user communication.

13. The method of claim 4, wherein identifying a relevancy indicator includes determining whether the recipient installed or updated software included within or linked with the user communication.

14. The method of claim 4, wherein one or more of the relevancy indicators are weighted differently than other ones of the relevancy indicators in determining a relevancy score.

15. The method of claim 1, wherein one or more of the relevancy scores are weighted differently than other ones of the relevancy scores in determining a relevancy value.

16. The method of claim 1, wherein the one or more user traits include one or more demographic traits including one or more of: age, gender, race, ethnicity and cultural heritage.

17. The method of claim 1, wherein the one or more user traits include one or more psychographic traits including one or more of: personality traits, interests, lifestyle traits and opinions.

18. The method of claim 1, wherein the one or more user traits include one or more location traits including one or more of: geographic region of residence or work location, state of residence or work location, city of residence or work location, population density, type of business performed at a particular work location, and type of work performed at a particular work location.

19. The method of claim 1, wherein the one or more user traits include one or more employment traits including one or more of: position within employer, title of position, type of position, level within employee management hierarchy, and job responsibility or responsibilities.

20. The method of claim 1, wherein the one or more user traits include one or more technological traits including one or more of: type of computer, type of portable computing device, type of smartphone or other cellular phone, brand of computer or other device, type of operating system, and type of software or software version the user currently has installed.

21. A computer implemented method for using a machine learning model to identify a set of enterprise users to receive a communication, the method comprising:
analyzing, by one or more computing systems, an enterprise-related user communication or a request to distribute an enterprise-related user communication;
determining, by the one or more computing systems, one or more contextual features for the user communication based on one or more of the content, subject, purpose and source of the user communication;
providing, by the one or more computing systems, the one or more determined contextual features to a machine learning model stored in one or more databases accessible by the one or more computing systems, the machine learning model including n dimensions for representing n respective user traits, each user trait having two or more possible values, the machine learning model further including a plurality of relevancy values associated with respective user trait values;
identifying, by the one or more computing systems, a target set of enterprise users to receive the user communication, the identifying including, for each of one or more of the determined contextual features:
determining, based on the relevance values in the machine learning model, one or more enterprise users of a plurality of candidate enterprise users that are associated with user trait values having respective relevancy values above a threshold; and
selecting the determined one or more enterprise users as the target set of enterprise users; and
distributing the user communication to the target set of enterprise users.

22. The method of claim 21, wherein:
the machine learning model is an n-dimensional model including n dimensions for representing n respective user traits, each user trait including two or more possible user trait values; and
the machine learning model further includes on or more decision boundaries, each decision boundary associated with one or more respective contextual features and crossing one or more of the n dimensions, each decision boundary separating a first set of one or more user trait values or combinations of user trait values having respective relevancy values above the threshold from a second set of one or more user trait values or combinations of user trait values having respective relevancy values below the threshold.

23. The method of claim 21, wherein distributing the user communication to the target set of enterprise users includes, for each user in the target set of enterprise users, causing the user communication to be displayed in a feed or list of communications associated with the user.

24. The method of claim 21, wherein distributing the user communication to the target set of enterprise users includes, for each user in the target set of enterprise users, sending the user communication in an email to the user.

25. The method of claim 21, wherein the one or more user traits include one or more demographic traits including one or more of: age, gender, race, ethnicity and cultural heritage.

26. The method of claim 21, wherein the one or more user traits include one or more psychographic traits including one or more of: personality traits, interests, lifestyle traits and opinions.

27. The method of claim 21, wherein the one or more user traits include one or more location traits including one or more of: geographic region of residence or work location, state of residence or work location, city of residence or work location, population density, type of business performed at a particular work location, and type of work performed at a particular work location.

28. The method of claim 21, wherein the one or more user traits include one or more employment traits including one or more of: position within employer, title of position, type of position, level within employee management hierarchy, and job responsibility or responsibilities.

29. The method of claim 21, wherein the one or more user traits include one or more technological traits including one or more of: type of computer, type of portable computing device, type of smartphone or other cellular phone, brand of computer or other device, type of operating system, and type of software or software version the user currently has installed.

30. The method of claim 21, wherein identifying the target set of enterprise users to receive the user communication also includes, for each of one or more combinations of two or more of the determined contextual features:
determining, based on the relevance values in the machine learning model, one or more enterprise users of the plurality of candidate enterprise users that are associated with user trait values having respective relevancy values above the threshold; and
selecting these determined one or more enterprise users to include in the target set of enterprise users.

31. A computer implemented method for determining relevancy values, the method comprising:
analyzing, by one or more computing systems, an enterprise-related user communication;
determining, by the one or more computing systems, a contextual feature for the user communication based on the user communication;
determining, by the one or more computing systems, one or more relevancy scores for each of one or more respective recipients of the user communication, each relevancy score based on one or more behaviors of the respective recipients with respect to the communication;
determining, by the one or more computing systems, one or more user traits associated with the one or more recipients of the user communication; and
based on the determined contextual feature, the one or more determined relevancy scores and the one or more determined user traits, generating one or more predicted relevancy values for the contextual feature and one or more user trait values.

32. The method of claim 31, wherein generating the one or more predicted relevancy values includes generating one or more predicted relevancy values for one or more combinations of two or more contextual features.
